(19) United States
(12) Patent Application Publication
(10) Pub. No.: US 2019/0108545 A1
(43) Pub. Date: Apr. 11, 2019

(54) AUTOMATICALLY DETECTING AND MODIFYING AN EXPLOIT DIGITAL ADVERTISING CAMPAIGN

(71) Applicant: Facebook, Inc., Menlo Park, CA (US)

(72) Inventors: Perry Aaron Green, San Francisco, CA (US); Eric Michael Sodomka, Foster City, CA (US); Siddharth Banothu, San Francisco, CA (US); Vipan Reddy Raja Nalla, San Jose, CA (US)

(21) Appl. No.: 15/728,026

(22) Filed: Oct. 9, 2017

(51) Int. Cl. G06Q 30/02

(52) U.S. Cl. CPC G06Q 30/0248; G06Q 30/0247; G06Q 30/0275

(57) ABSTRACT

The present disclosure is directed toward systems, methods, and computer-readable media that automatically detect and correct advertising exploits for an advertising campaign. For instance, one or more of the systems disclosed herein employs various metrics to automatically determine when an advertising campaign exceeds an exploit threshold. In addition, upon determining that an advertising campaign is an exploit campaign, one or more of the disclosed systems automatically throttles the execution of an advertising campaign until the exploit is corrected. For example, the disclosed system can modify one or more of the campaign parameters of the exploit campaign to limit placement of at least one future advertisement from the advertising campaign.

### BACKGROUND

Advancements in computing devices and networking technology have led to a variety of innovations in providing targeted digital content across computer networks. For example, online digital content systems are now able to instantly serve targeted digital content to users via a variety of user computing devices. Indeed, whether in entertainment, advertising, or employment, online digital content systems are able to provide instantaneous targeted digital content to thousands of users via recipient client devices.

Despite these advances, however, conventional digital content systems continue to have a number of problems. To illustrate, modern online advertising systems can execute digital advertising campaigns and provide targeted digital content to particular users via computing networks, as users utilize one or more online applications. However, many advertisers have identified ways to exploit vulnerabilities of these modern online advertising systems. For example, some advertisers can design online advertisement campaigns (i.e., “exploit campaigns”) with parameters that result in placement of advertisements at a significantly reduced cost (e.g., a cost that is substantially less than anticipated, or agreed upon, by the online advertising system). Indeed, in some cases, advertisers find an exploit or vulnerability that enables them to execute a sophisticated advertising campaign at no cost. For instance, a malicious advertiser can agree to pay an online advertising system for each click of an advertisement by a client device, but then deploy an advertisement that does not include any clickable links (resulting in free placement of the link-free advertisement).

In addition, many modern online advertising systems can inadvertently introduce vulnerabilities that result in lost revenue. For example, modern online advertising systems employ a variety of individuals to maintain, implement, and execute software and hardware components for providing digital content. Errors in any one of these components can inadvertently introduce a new vulnerability that allows advertisers to unjustifiably reduce the cost of providing digital content to users. Accordingly, even for advertisers that are not purposefully seeking to exploit an online advertising system, vulnerabilities can still arise that result in an unnecessary reduction in revenue through exploit campaigns.

The problem of such exploit campaigns is a direct result of the volume and speed of modern online advertising systems. Indeed, in order to provide digital content in real-time, modern online advertising systems apply complex digital parameters to select and provide digital content to millions (or even billions) of client computing devices interfacing via global computer networks. Application of these digital parameters across such complex systems routinely results in system vulnerabilities. Moreover, at such large volumes and speeds, it is extremely difficult to detect and patch vulnerabilities until after millions of dollars of advertising revenue have already been lost.

In addition to significant revenue loss, exploit campaigns have a number of other significant adverse consequences. For example, legitimate advertisers suffer as they are excluded from providing digital content to potential customers. Similarly, individual consumers are harmed as exploit campaigns circumvent modern systems for providing relevant, interesting digital content and, instead, users receive digital content that is irrelevant, irritating, or offensive. Furthermore, the process of identifying and patching vulnerabilities places a significant burden on modern online advertising system, as numerous employees are utilized to monitor advertising campaigns (around the clock) to detect and minimize the damage of exploit campaigns.

These and other problems exist with regard to providing digital content to client devices over computing networks.

### SUMMARY

Embodiments described herein provide benefits and/or solve one or more of the foregoing or other problems in the art by providing systems, methods, and computer-readable media that automatically detect and correct exploit campaigns in providing digital content to client computing devices. For instance, one or more of the systems disclosed herein automatically determine when a digital advertising campaign (or simply “advertising campaign”) exceeds an exploit threshold. In particular, the disclosed systems can estimate a displaced value for winning bids in an online auction over a particular period of time and monitor an actual revenue amount for the winning bids. Further, the disclosed systems can determine that an advertising campaign is an exploit campaign by comparing the displaced value and the actual revenue amount to an exploit threshold. Upon determining that an advertising campaign is an exploit campaign, the disclosed systems can automatically throttle execution of the advertising campaign (e.g., until the advertising campaign is corrected). In this manner, the systems, methods, and computer-readable media can automatically detect, reduce, and remedy exploit campaigns by advertisers in delivering digital content to client computing devices.

To illustrate, in one or more embodiments, the disclosed systems identify, from a real-time online automated advertising auction, winning bids for an advertising campaign during a first time period. For the advertising campaign and during the first time period, the systems determine a displaced value for the advertising campaign (i.e., a predicted amount of revenue from the advertising campaign for winning bids that occur in the first time period). In addition, the disclosed systems identify an actual revenue amount associated with the advertiser for winning bids that occur in the first time period. Then, based on the displaced value and the actual revenue amount, the systems determine whether the advertising campaign is an exploit campaign. Further, based on the determination that the advertising campaign is an exploit campaign, the systems automatically throttle further execution of the advertising campaign.

In one or more embodiments, the disclosed systems monitor actual revenue from an advertiser for a predetermined second period of time to receive additional information pertaining to winning bids that occur in the first time period, but that were not executed and/or reported during the first period. In this manner, the disclosed systems can accurately detect and correct exploit campaigns in real-time or near-real-time before an exploit campaign has caused significant damage.

Additional features and advantages of the present application will be set forth in the description which follows, and in part will be obvious from the description, or may be learned by the practice of such example embodiments.

### BRIEF DESCRIPTION OF THE DRAWINGS

To better describe the manner in which the systems and methods obtain the advantages and features of the disclosed embodiments, a number of example embodiments are described in connection with accompanying drawings. The following paragraphs briefly describe those figures.

FIG. 1 illustrates a schematic diagram of an exemplary environment in which a digital exploit management system may be implemented in accordance with one or more embodiments.

FIGS. 2A-2B illustrate a sequence diagram of identifying and throttling an exploit campaign in accordance with one or more embodiments.

FIG. 3 illustrates an example graph of displaced value and actual revenue for an exploit campaign in accordance with one or more embodiments.

FIG. 4 illustrates an example timeline of a monitored time period for an advertising campaign in accordance with one or more embodiments.

FIG. 5 illustrates an example table that displays timestamps associated with events from multiple advertisements in accordance with one or more embodiments.

FIG. 6 illustrates an example graph of detecting, throttling, and un-throttling an advertising campaign in accordance with one or more embodiments.

FIG. 7 illustrates a flow diagram of employing throttling safeguards in accordance with one or more embodiments.

FIG. 8 illustrates a schematic diagram of the digital exploit management system in accordance with one or more embodiments.

FIG. 9 illustrates a flowchart of a method of automatically throttling an exploit campaign in accordance with one or more embodiments described herein.

FIG. 10 illustrates a block diagram of a computing device in accordance with one or more embodiments described herein.

FIG. 11 illustrates a network environment of a social networking system in accordance with one or more embodiments described herein.

FIG. 12 illustrates an example social graph of a social networking system in accordance with one or more embodiments described herein.

### DETAILED DESCRIPTION

One or more embodiments disclosed herein include a digital exploit management system that automatically detects and remedies exploit campaigns. More specifically, the digital exploit management system can identify, in real-time or near-real-time, when an advertising campaign satisfies an exploit threshold. Moreover, in one or more embodiments, the digital exploit management system throttles future execution of the exploit campaign to prevent the advertising campaign from causing significant damage to users, other clients, and advertising systems. Further, as mentioned above, the digital exploit management system can automatically provide exploit campaign detection and correction without user involvement or interaction.

For example, in one or more embodiments, the digital exploit management system operates an online automated auction. In particular, the digital exploit management system gathers and compares real-time bids amongst a variety of advertisers for impression opportunities corresponding to client devices accessing a networking system. Via the online automated advertising auction, the digital exploit management system can identify winning bids from an advertising campaign during a first time period. During execution of the advertising campaign, the digital exploit management system can determine a displaced value for the first time period, where the displaced value is a predicted amount of revenue that the advertising campaign should generate. In addition, the digital exploit management system can identify an actual revenue amount for the advertising campaign corresponding to the winning bids in the first time period. Based on the displaced value, the actual revenue amount, and an exploit threshold, the digital exploit management system can determine whether the advertising campaign is an exploit campaign. Furthermore, if the advertising campaign is determined to be an exploit campaign, the digital exploit management system can automatically throttle the advertising campaign to limit placement of future advertisements from the advertising campaign.

As mentioned previously, an advertiser may setup an exploit campaign in a variety of different ways. For example, in some circumstances, an advertiser agrees to pay a revenue amount each time a user clicks an advertisement, but the advertiser removes all clickable links when deploying the advertisement. Thus, even though the advertisement is repeatedly served, users cannot click the advertisement, which reduces or eliminates actual revenue from the advertiser. In another example, an advertiser sets a bid price (e.g., $10) that is higher than a total budget (e.g., $5). If a policy is in place to not charge an advertiser more than the allocated budget, the advertiser can place advertisements without payment.

As mentioned above, in one or more embodiments the digital exploit management system employs an exploit threshold to identify and remedy these (or other) exploit campaigns. For example, in one or more embodiments, the digital exploit management system determines that an advertising campaign is an exploit campaign if the displaced value is a multiple (e.g., ten times (10×) or fifty times (50×)) of the actual revenue amount. In some embodiments, the digital exploit management system determines that an advertising campaign is an exploit campaign when the displaced value is a threshold number of dollars above the actual revenue amount and/or the actual revenue amount is at or below a minimum value (e.g., zero dollars).

In one or more embodiments, the digital exploit management system can monitor actual revenue values corresponding to an advertiser beyond the time period for detecting winning bids. Indeed, as a result of time lag between a winning bid, placing digital content, and identifying actual revenue amounts, the digital exploit management system can monitor revenues for an additional time period to avoid inaccurately identifying an exploit campaign. For example, in one or more embodiments, the digital exploit management system receives actual revenue information during a monitored time period that includes the first time period (i.e., the time period for awarding winning bids) as well as a predetermined second time period. In this manner, for most winning bids that occur within the first time period, the digital exploit management system waits and includes the outcomes of these bids when determining whether an advertising campaign is an exploit campaign. Further, by employing the monitored time period, the digital exploit management system can rapidly detect exploit campaigns before they cause significant damage while also preventing improperly characterization of an advertising campaign as an exploit campaign.

As mentioned above, the digital exploit management system can also throttle the advertising campaign to limit execution of the advertising campaign in the future. For instance, the digital exploit management system can modify one or more campaign parameters of the advertising campaign to limit placement of one or more future advertisements from the advertising campaign. To illustrate, the digital advertisement management system can modify a budget for an advertising campaign to limit future placements.

Further, as detailed below, the digital exploit management system can likewise un-throttle and/or increasingly throttle an advertising campaign. For example, upon monitoring an advertising campaign for a third period of time, the digital exploit management system can determine that the advertising campaign is no longer an exploit campaign (e.g., one or more vulnerabilities have been resolved) and un-throttle the advertising campaign. Conversely, the digital exploit management system can monitor an exploit campaign for a third period of time, determine that the advertising campaign is still an exploit campaign, and further throttle the exploit campaign (e.g., completely pause execution of the exploit campaign). In this manner, the digital exploit management system can automatically manage and remedy exploit campaigns without user intervention.

In one or more embodiments, the digital exploit management system provides additional checks and assurances to ensure that advertising campaigns are being accurately throttled. For example, the digital exploit management system can perform system-wide checks to determine if a global throttling threshold is being violated. For instance, if the digital exploit management system determines that a threshold percentage of advertising campaigns are being throttled, the digital exploit management system can pause throttling of one or more advertising campaigns to determine whether a fault has been introduced to the digital exploit management system.

The digital exploit management system provides numerous advantages and benefits over conventional advertising systems. Indeed, as discussed above, some advertisers take advantage of vulnerabilities or loop-holes in a digital advertising system such that the advertiser does not pay the digital advertising system a fair and equitable value for their advertising campaign. Rather, these advertisers pay the digital advertising system a significantly reduced rate (or in some cases nothing) for their exploitive advertising campaign (or simply “exploit campaign”). Because of the volume of digital content and the corresponding speed of online systems (e.g., performing auctions within milliseconds of receiving millions of impression opportunities), a system administrator typically discovers an exploit campaign long after the damage has been done. In addition, by the time a malicious exploit campaign is discovered, the malicious advertiser has often created new and additional exploit campaigns. Further, with conventional advertising systems, even if a system administrator does detect an ongoing exploit campaign, the system administrator must often manually remedy the exploit (e.g., by trying to contact the advertiser).

In contrast, the digital exploit management system can quickly, efficiently, and automatically discover when an advertising campaign is an exploit campaign. Indeed, depending on the embodiment, the digital exploit management system can automatically identify an exploit campaign within minutes of executing the exploit campaign. Accordingly, the digital exploit management system can avoid unnecessary damage (e.g., monetary losses, exclusion of legitimate advertisers, and/or frustration to consumer clients) as exploit campaigns improperly take advantage of impression opportunities.

Furthermore, the digital exploit management system can automatically remedy the exploit campaign. Indeed, the digital exploit management system can automatically modify one or more campaign parameters to throttle additional placements from an exploit campaign. Moreover, the digital exploit management system can continue to monitor the advertising campaign and determine whether the throttling was necessary or whether to un-throttle/modify the throttling levels.

In addition, as mentioned above, the digital exploit management system provides the benefit of conducting system-wide checks and assurances. For instance, if an employee introduces a bug or error to an advertising system that creates a global exploit, the digital exploit management system can detect and automatically adjust the exploit campaigns to minimize overall damage. Further, the digital exploit management system can report or identify a global exploit for correction upon detection such that any system-wide fault or bug can be quickly remedied.

For reference, as used herein, the term “digital advertisement” refers to digital content or data that is transmitted over a communication network (e.g., the Internet or an intranet). In particular, a “digital advertisement” includes digital content that promotes a product, service, or other offering by an entity (e.g., an advertiser). A digital advertisement can include, but is not limited to, text, images, audio, and/or audiovisual content. In one example, a web page displays one or more digital advertisements to a user viewing the web page. In another example, a user views a digital advertisement in connection with viewing other audiovisual content. For example, in one or more embodiments, a digital advertisement is offered as part of a social networking news feed or as a digital advertisement within a messaging application.

The terms “digital advertising campaign” or “advertising campaign” refer to a series of actions, rules, and/or processes for disseminating one or more digital advertisements. In particular, an advertising campaign includes one or more digital advertisements and one or more campaign parameters for disseminating the one or more digital advertisements. To illustrate, an advertising campaign includes an advertisement together with campaign parameters for bidding on impression opportunities, sending advertisements to client devices, or targeting particular client devices and/or users.

As used herein, the term “campaign parameters” includes factors, rules, or criteria that define the conditions or operation of an advertising campaign. For example, campaign parameters can include (but are not limited to) campaign objectives (e.g., traffic, exposure, impressions, clicks, downloads, lead generations, shares, app installs, video views, conversions, or sales), the costs the advertiser is willing to spend on an advertising campaign (e.g., daily budget and lifetime budgets), bidding preferences (e.g., max bid amount, minimum bid amount, or bid variations), targeting parameters (e.g., characteristics of clients, devices, locations, or media to target with an advertisement), the duration and schedule of the campaign, and/or the reach of the campaign. Additional examples of campaign parameters can include the communications channel on which to advertise (e.g., websites, search results, social networks, messaging applications, mobile applications, or multiple channels), billing preferences (e.g., how much and how often to bill), and advertisements to include in the advertising campaign (e.g., text, images, and video). Thus, an advertising campaign includes campaign parameters that define the objective, budget, scope, and duration of the advertising campaign.

The term “impression opportunities,” as used herein, refers to an available opportunity, slot, or space for providing digital content (e.g., for providing a digital advertisement). In particular, an impression opportunity includes an available advertising space on a communication network where a digital advertisement could be served or presented. An impression opportunity can include a variety of opportunities in a variety of different digital media, such as, a webpage or a networking system (e.g., a social networking system, a messaging system). Similarly, the term “impression” refers to digital content retrieved from a source (e.g., via a remote server) to be served for a particular purpose (e.g., served in an advertising slot or space to a client device). In particular, an impression corresponds to a countable event for when a digital advertisement is retrieved and served (e.g., regardless of whether a user views or otherwise interacts with the digital advertisement).

As mentioned above, an online automated auction server or system may auction off impression opportunities to an advertising campaign that corresponds to a winning bid. As used herein, the term “winning bid” refers to a bid selected by an online automated auction. As outlined below, the digital exploit management system can utilize a variety of parameters for determining a winning bid (e.g., highest bid, relevance or appropriateness of the advertisement to a particular user).

As mentioned, the digital exploit management system can calculate a displaced value corresponding to winning bids of an advertising campaign. As used herein, the term “displaced value” refers to a predicted monetary amount (i.e., from an advertiser) corresponding to one or more winning bids. In particular, the “displaced value” includes an estimated amount that can be billed to, collected from, or otherwise attributable to an advertiser resulting from one or more winning bids. In some embodiments, a displaced value is limited to a set period of time, such as displaced value for all winning bids within an hour, 3-hours, a day, a week, or a month.

The terms “actual revenue” or “legal revenue” as used herein refer to the monetary amount charged (or to be charged) for delivered advertisements within an advertising campaign. For instance, “actual revenue” includes the monetary amount attributable to, associated with, debited from, invoiced to, billed to, or collected from an advertiser for placement of advertisements from an advertising campaign. Depending on the advertising campaign and/or auction bid, actual revenue can be based on impressions, views, clicks, “likes,” shares, downloads, or other triggering events. In some instances, actual revenue for an advertising campaign is determined based on a specific time period. Actual revenue is distinguishable from displaced value in that (among other things) displaced value is an estimate based on winning bids, whereas actual revenue is calculated based on placement of advertisements via client devices.

As used herein, the terms “exploit campaign” or “cheap delivery” refers to an advertising campaign with depressed actual revenue. In particular, the term “exploit campaign” includes an advertising campaign with one or more features that causes the advertising campaign to result in less actual revenue than anticipated. For instance, the term “exploit campaign” includes an advertising campaign whose displaced value is larger than the actual revenue (e.g., by an exploit threshold). Thus, an advertiser receives the benefit of delivered advertising for less than an agreed upon cost. An exploit campaign is often the result of a delivery exploit. As used herein, the term “delivery exploit” refers to a vulnerability in the digital exploit management system that enables an advertiser to maliciously or non-maliciously execute an exploit campaign.

The term “throttling” refers to controlling service of one or more advertisements of an advertising campaign. In particular, “throttling” includes modifying one or more campaign parameters to limit at least one placement of a future advertisement from the advertising campaign. For example, the digital exploit management system can throttle an advertising campaign by modifying the campaign parameters of the advertising campaign (e.g., lowering a bid amount or budget), which results in the advertising campaign winning fewer bids (e.g., the advertising campaign bids at a lesser and/or discounted bid value). Additional examples of throttling an advertising campaign are provided below.

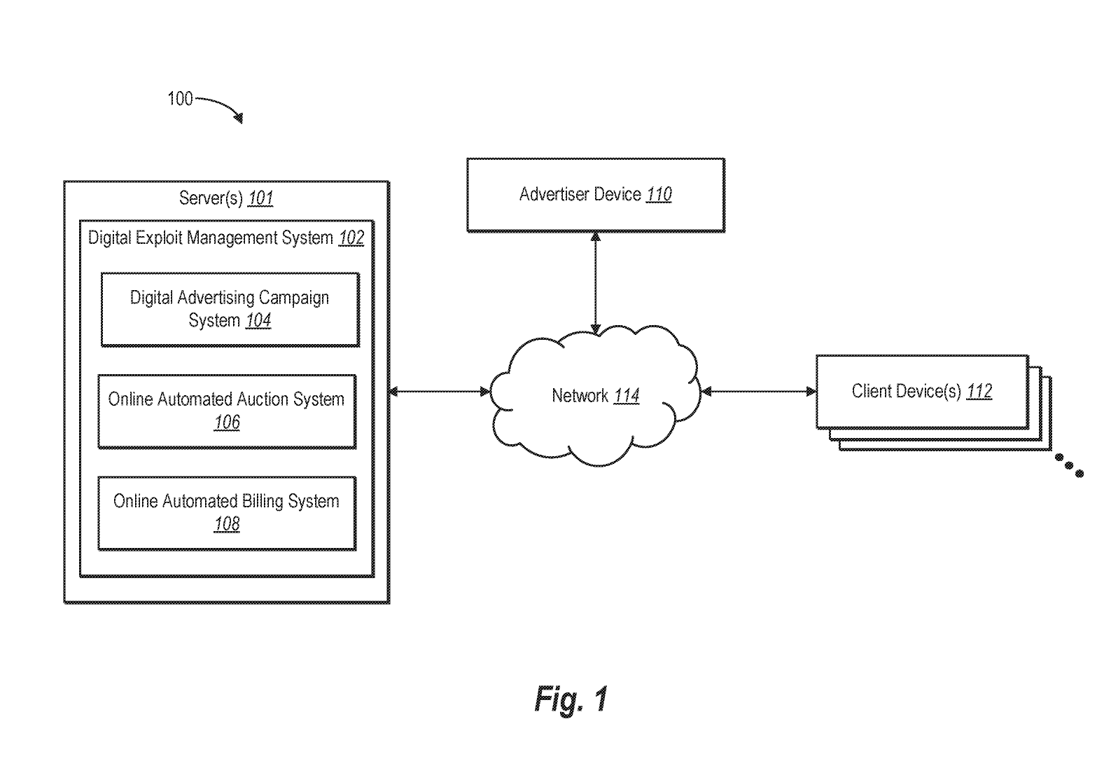

As mentioned above, the digital exploit management system provides a number of advantages and benefits over conventional systems. Additional advantages and benefits will become evident as illustrative embodiments are described in connection with the figures. To illustrate, FIG. 1 shows a schematic diagram of an environment 100 in which a digital exploit management system 102 may be implemented in accordance with one or more embodiments. As shown, the environment 100 includes server(s) 101 implementing the digital exploit management system 102 in conjunction with a digital advertising campaign system 104, an online automated auction system 106, and an online automated billing system 108.

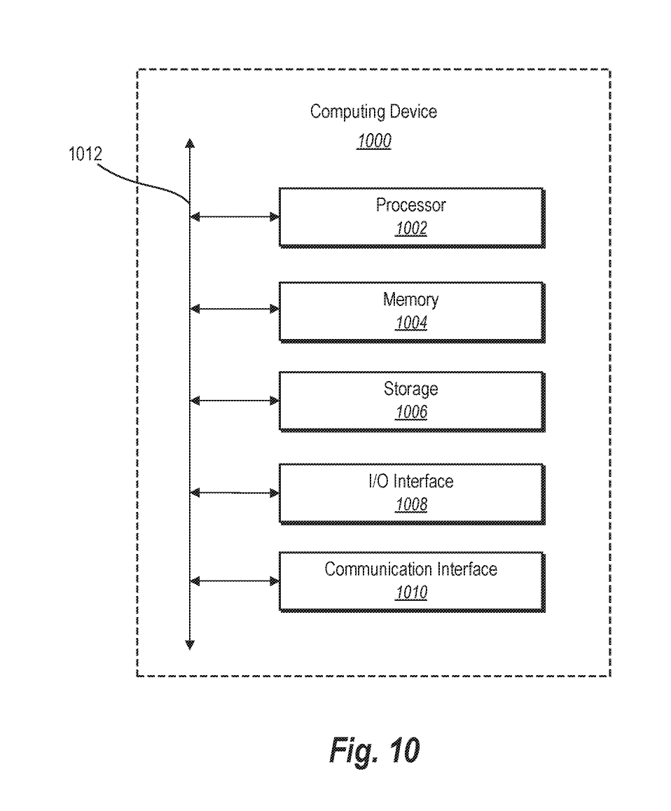

As shown in FIG. 1, the environment 100 may include the server(s) 101. The server(s) 101 may generate, store, receive, and transmit any type of data. For example, the server(s) 101 may transmit data to a client device, such as one of the client device(s) 112. In one example embodiment, the server(s) 101 comprise a content server. The server(s) 101 can also comprise a communication server or a web-hosting server. Additional details regarding the server(s) 101 will be discussed below with respect to FIG. 10.

As shown, the server(s) 101 can implement (e.g., host) the digital exploit management system 102, the digital advertising campaign system 104, the online automated auction system 106, and the online automated billing system 108. As discussed above the digital exploit management system 102 can detect when an advertising campaign is an exploit campaign as well as throttle placement of future advertisements that are part of an exploit campaign.

In general, the digital advertising campaign system 104 manages advertising campaigns as well as serves advertisements to client devices. The online automated auction system 106 facilitates online auctions between different advertising campaigns. Moreover, the online automated billing system 108 collects actual revenue attributable to (e.g., billed to or able to be billed to) an advertiser and reports billing information back to the digital advertising campaign system 104.

While FIG. 1 shows the digital exploit management system 102, the digital advertising campaign system 104, the online automated auction system 106, and the online automated billing system 108 located on the server(s) 101, each of these systems can be implemented on the same or different servers. For example, in one or more embodiments, the advertising campaign system 102 is implemented via a first set of servers, the online automated auction system 106 is implemented via a second set of servers, and/or the online automated billing system 108 is implemented via a third set of servers.

Moreover, although FIG. 1 illustrates the digital exploit management system 102 implementing the digital advertising campaign system 104, the online automated auction system 106, and the online automated billing system 108, in some embodiments, the digital exploit management system 102 can be implemented (in whole or in part) within one or more of the digital advertising campaign system 104, the online automated auction system 106, and the online automated billing system 108. For example, in one or more embodiments, the digital exploit management system 102 is implemented (e.g., hosted) as part of the digital advertising campaign system 104.

As shown in FIG. 1, the environment 100 also includes an advertiser device 110 and client device(s) 112. The advertiser device 110 and/or the client device(s) 112 may comprise any computing device. For instance, in various embodiments, one or more of the advertiser device 110 and/or the client device(s) 112 comprise one or more computing devices described below in relation to FIG. 10. In addition, while FIG. 1 shows one advertiser device 110, the environment 100 can include any number of advertiser devices.

The components of the environment 100 (e.g., the server(s) 101, advertiser device 110, the client device(s) 112, the digital advertising campaign system 104, the digital exploit management system 102, the online automated auction system 106, and the online automated billing system 108) can communicate via the network 114. For example, the advertiser device 110 can provide campaign parameters for an advertising campaign to the digital advertising campaign system 104. In another example, the client device 112 can receive advertisements from the digital advertising campaign system 104. The network 114 may be any suitable network over which the computing devices can communicate. Example networks are discussed in more detail below with regard to FIG. 10.

As mentioned above, in one or more embodiments, the digital exploit management system 102 can detect and throttle an exploit campaign. By way of example, an advertiser wanting to promote a product or service indicates (e.g., via the advertiser device 110) one or more digital online advertisements to include in a digital advertising campaign. Further, the advertiser (e.g., via the advertiser device 110) specifies additional campaign parameters, such as a target audience, a budget, and/or a bidding amount.

The digital exploit management system 102 (e.g., via digital advertising campaign system 104) receives the campaign parameters from the advertiser device 110. Moreover, the digital exploit management system 102 (e.g., via the digital advertising campaign system 104) provides the campaign parameters to the online automated auction system 106. The online automated auction system 106 detects impression opportunities via client devices (e.g., the client device(s) 112) interacting with various digital media platforms (e.g., websites, social networking newsfeeds, or messaging applications). Moreover, to determine which advertising campaign will populate an impression opportunity, the online automated auction system 106 hosts an online automated auction (e.g., according to the campaign parameters provided by the advertiser device 110). The advertising campaign with the winning bid is used to populate (e.g., via the digital advertising campaign system 104) the available impression opportunities. In response, the online automated auction system 106 can bill (e.g., attribute revenue) from the advertiser to the digital exploit management system 102 for serving the digital advertisement.

The process of bidding within the online auction and serving advertisements corresponding to the winning bids often occurs within milliseconds. Further, an online auction can occur for each impression opportunity (e.g., each advertisement slot on a web page) that is presented to an individual user. In this manner, the number of online auctions that occur with a short time period can easily reach into the millions.

In some instances, however, the advertising campaign is an exploit campaign that results in the advertiser being charged an unfairly discounted amount. To address this problem, the digital exploit management system 102 (e.g., via the online automated auction system 106) can estimate a displaced value for the advertising campaign at the time of auction based, in part, on the winning bids. Moreover, the digital exploit management system 102 (e.g., via the online automated billing system 108) can determine an actual revenue amount corresponding to the winning bids. The digital exploit management system 102 (e.g., via the digital advertising campaign system 104) can analyze the displaced value and actual revenue amount for a period of time and determine that the advertising campaign is an exploit campaign. Furthermore, the digital exploit management system 102 can throttle the advertising campaign (e.g., via the online automated auction system 106 or the digital advertising campaign system 104) to minimize the adverse effects of the exploit campaign.

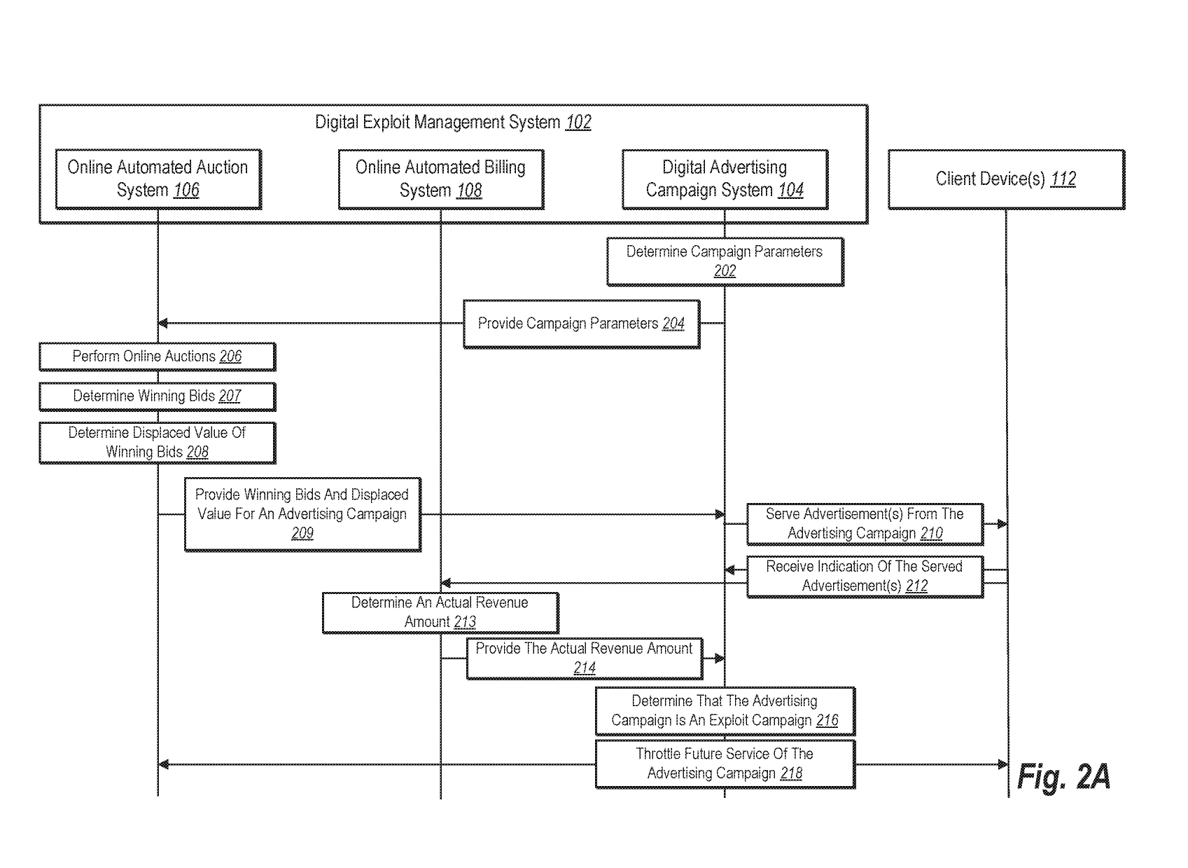

Turning now to FIGS. 2A-2B, additional detail is provided regarding the digital exploit management system 102 identifying and throttling an exploit campaign. For instance, FIG. 2A illustrates a sequence diagram of a series of acts 202-218 for identifying and throttling an exploit campaign in accordance with one or more embodiments. As shown in FIG. 2A, the acts 202-218 are performed by the digital exploit management system 102 via the online automated auction system 106, the online automated billing system 108, and the digital advertising campaign system 104 (and/or the client device(s) 112). Further, while not shown, the sequence diagram in FIG. 2A could also include an advertiser device (e.g., the advertising device 110).

As illustrated in FIG. 2A, the digital exploit management system 102 determines 202 campaign parameters. For example, the act 202 can include receiving campaign parameters from an advertiser (e.g., via an advertising device). In particular, in relation to the embodiment of FIG. 2A, an advertiser provides, via an advertising device, campaign parameters for one or more advertising campaigns. In other embodiments, the digital exploit management system 102 can determine the campaign parameters automatically (e.g., by analyzing the contents of an advertisement or based on previous campaign parameters of an advertiser or other advertisers).

As mentioned above, campaign parameters can include one or more rules, objectives, or preferences for providing an advertisement to a client device. As mentioned above, campaign parameters can include campaign objectives, costs, schedule, reach, preferences (e.g., bidding and targeting), and/or advertisements. Additional examples of campaign parameters can include the communications channel on which to advertise, billing preferences, and advertisements to include in the advertising campaign.

As illustrated in FIG. 2A, the digital exploit management system 102 (e.g., via the digital advertising campaign system 104) can also provide 204 campaign parameters to the online automated auction system 106. For example, the digital exploit management system 102 provides the campaign parameters for multiple advertising campaigns to the online automated auction system 106. Moreover, the online automated auction system 106 can perform 206 online auctions. In particular, the online automated auction system 106 can perform 206 online auctions based on the campaign parameters for multiple advertising campaigns.

For instance, the online automated auction system 106 provides a real-time online automated auction forum where advertisers (based on their campaign parameters) bid against each other for impression opportunities. To illustrate, the online automated auction system 106 receives and/or determine (e.g., via the digital advertising campaign system 104) impression opportunities from a variety of sources, such as web sites, networking systems, or mobile applications.

The online automated auction system 106 also receives and/or determine characteristics corresponding to various impression opportunities. For example, the online automated auction system 106 can determine a communication medium corresponding to an impression opportunity (e.g., a particular web page, social networking system, messaging application, or mobile application). Moreover, the online automated auction system 106 can determine characteristics of a user (e.g., male, 30-35, and likes fly fishing) or device (e.g., manufacturer, installed applications, and operating system) corresponding to the impression opportunity.

Furthermore, the online automated auction system 106 can compare characteristics of an impression opportunity with campaign parameters. For instance, the online automated auction system 106 can determine that an impression opportunity matches the targeting parameters of a particular advertising campaign (e.g., an advertiser seeks to target females between 20 and 25 and the advertiser corresponds to a female user that is 22). In this manner, the online automated auction system 106 identifies which advertising campaign that best fits the impression opportunity as part of the bidding process.

Moreover, the online automated auction system 106 generates a bid for each advertising campaign. Based on the campaign parameters and characteristics of the impression opportunity, the online automated auction system 106 can adjust bids for each impression opportunity. For example, the online automated auction server can increase a bid for an advertising campaign with campaign parameters that match characteristics of an impression opportunity or lower bid for advertising campaigns with campaign parameters that do not match characteristics of the impression opportunity.

Depending on the embodiment (and/or campaign parameters of various advertisers), the digital exploit management system 102 can receive, generate, and compare a variety of different bids. For instance, in some embodiments, the online automated auction system 106 receives bids that reflect an amount per impression (e.g., $0.10 per impression). In other embodiments, the online automated auction system 106 generates bids that reflect an amount based on different triggering events, such as an amount per click (e.g., $0.15 per click), an amount per view (e.g., $0.01 per view), or an amount per download (e.g., $1.00 per download).

In sum, the online automated auction system 106 analyzes received campaign parameters for each advertising campaign and creates bids to win impression opportunities. Using the bids, the online automated auction system 106 executes an online auction for impression opportunities.

As shown in FIG. 2A, the online automated auction system 106 also determines 207 winning bids for impression opportunities. In particular, each online auction results in a winning bid for an advertising campaign. More specifically, an advertising campaign wins a bid for a particular advertisement from the advertising campaign. As mentioned, the online automated auction system 106 also determines a winning bid based on a variety of factors. For instance, in some embodiments the online automated auction system 106 can determine the winning bid based solely on the highest dollar bid. In other embodiments, the online automated auction system 106 can determine the winning bid based on other factors, such as a correspondence between user preferences and the contents of an advertisement or appropriateness (or offensiveness) of an advertisement for a particular user.

As shown in FIG. 2A, upon determining winning bids for impression opportunities, the online automated auction system 106 also determines 208 a displaced value of the winning bids. In particular, the digital exploit management system 102 estimates a displaced value that reflects a predicted amount of revenue from the advertiser that will result from the winning bid and corresponding impression opportunity.

The displaced value will vary depending on the type bid. As mentioned above, in some embodiments, a bid reflects an amount per impression opportunity. The digital exploit management system 102 can determine a displaced value based on the bid amount. For example, the digital exploit management system 102 can multiply the number of winning bids for an advertising campaign by the bid amount for each winning bid to determine the displaced value for the advertising campaign (e.g., 100 impression opportunities at $0.10 for a displaced value of $10).

As mentioned above, in other embodiments, a bid reflects an amount based on some other triggering event (such as an amount per click, purchase, or download). In such embodiments, the digital exploit management system 102 can estimate a displaced value based on an anticipated number of triggering events and a bid amount. For instance, with regard to a bid that includes an amount per click, the digital exploit management system 102 can look to historical performance data for one or more advertisers to determine an average number of clicks per impression opportunity. The digital exploit management system 102 can then multiply the average number of clicks per impression opportunity by the bid amount to determine a displaced value (e.g., 100 impression opportunities, anticipated click rate of 50%, at $0.10 per click, for a displaced value of $5).

In addition to the foregoing examples, the digital exploit management system 102 can utilize a variety of different approaches to determine a displaced value. For example, in one or more embodiments, the digital exploit management system 102 utilizes a machine learning model trained from historical performance of advertisements to estimate a displaced value for a particular advertisement. In other embodiments, the digital exploit management system 102 can utilize a value prediction model for estimating a displaced value for an advertisement.

In one or more embodiments, the online automated auction system 106 determines a displaced value for an advertising campaign over a period of time. Specifically, the online automated auction system 106 can aggregate displaced value for each winning bid of an advertising campaign during a time period. For example, the online automated auction system 106 can analyze winning bids for a specific time period (e.g., 30 minutes, an hour, 3 hours, or a day) and determine a number of winning bids corresponding to a particular advertising campaign (e.g., 50 winning bids). The online automated auction system 106 can determine a displaced value for the advertising campaign during the specific time period (e.g., 50 winning bids at $0.10 per impression opportunity results in $5).

In one or more embodiments, the online automated auction system 106 can discount a displaced value by accounting for failed impression opportunities (i.e., an estimated number of impression opportunities that likely will not result in a desired user action. To illustrate, even though an advertising campaign wins an impression opportunity, a certain percentage of the impressions (or conversions) may fail (e.g., the client device(s) 112 will fail to download the advertisement or the digital advertising campaign system 104 will fail to provide an advertisement). The digital exploit management system 102 can modify displaced value to account for such failed impressions (or conversions).

As illustrated in FIG. 2A, the online automated auction system 106 also provides 209 the winning bids and a displaced value for an advertising campaign to the digital exploit management system 102. Moreover, the digital advertising campaign system 104 serves (e.g., places) 210 advertisement(s) from the advertising campaign to the client device(s) 112. For instance, in one or more embodiments, upon receiving advertisement(s) corresponding to the winning bids for impression opportunities, the digital advertising campaign system 104 serves the advertisement(s) to the client device(s) 112 corresponding to the various impression opportunities. For example, if an impression opportunity was for a video advertisement within a streaming video to a college age female in California, the digital advertising campaign system 104 provides the advertisement to the client device of the college age female in California during the streaming video.

Upon providing the advertisement(s), the digital advertising campaign system 104 receives 212 an indication of the served advertisement(s) on the client device(s) 112. For example, in one or more embodiments the client device(s) 112 directly provides an indication to the digital advertising campaign system 104. In another example, the digital advertising campaign system 104 detects that the client device(s) 112 requests the advertisement, resulting in a counted impression. In some embodiments, the digital advertising campaign system 104 detects a click, download, an engagement, or a conversion, which indicates user interaction with the advertisement. For instance, the digital exploit management system 102 can utilize a tracking cookie or server-side tracking methods to determine that the advertisement(s) were served to the client device(s) 112 and/or to detect some other user interaction or conversion.

As shown in FIG. 2A, the online automated billing system 108 also receives 212 the indication of the server advertisement(s) on the client device(s) 112. To illustrate, the online automated billing system 108 can receive an indication of a user interaction at the client device(s) 112 that corresponds to a triggering event for billing (e.g., billing the advertiser according to the agreed upon terms of the winning bid).

While FIG. 2A shows the online automated billing system 108 receiving an indication of a served advertisement from the client device(s) 112, the indication can be received from the digital advertising campaign system 104 or a third-party server. In addition, the indication may signify a different type of triggering event for billing (or multiple triggering events), as described above.

As shown in FIG. 2A, the online automated billing system 108 can also utilize indications received from the client device(s) 112 to determine 213 an actual revenue amount. For example, the online automated billing system 108 can determine advertisements, conversions, or user interactions detected via the client device(s) 112 and determine an actual revenue amount attributable to (i.e., billable to) an advertiser. For example, the online automated billing system 108 can determine a winning bid for an advertiser and apply the winning bid to the actual advertisements, conversions, or user interactions detected via the client device(s) 112. To illustrate, the online automated billing system 108 can detect that client device(s) 112 clicked on 500 different advertisements of an advertiser, determine that the advertiser bid $0.07 per click, and then determine an actual revenue amount (i.e., to bill to the advertiser) of $35.

As discussed in greater detail below, the digital exploit management system can receive, monitor, and/or track various timestamps corresponding to advertisements and/or billing. For instance, the digital exploit management system 102 can determine a time corresponding to a winning bid, a time corresponding to placing an advertisement, a time corresponding to user interaction with an advertisement, or a time when revenue is attributed to an advertiser (e.g., a time when an internal advertiser account is billed or debited). The digital exploit management system 102 can utilize these timestamps to determine an actual revenue amount corresponding to a particular time period. For example, the digital exploit management system 102 can utilize timestamps to determine actual revenue corresponding to bids won by an advertiser during a particular period of time.

As shown, upon calculating the actual revenue amount, the online automated billing system 108 provides 214 the actual revenue amount to the digital exploit management system 102 via the digital advertising campaign system 104. In one or more embodiments, the online automated billing system 108 provides or updates the actual revenue amount for an advertising campaign each time a triggering event for billing for the advertising campaign occurs. In alternative embodiments, the online automated billing system 108 sends actual revenue information for an advertising campaign to the digital exploit management system 102 at regular intervals (e.g., every 15-minutes, 30-minutes, or 1 hour) or for a determined period of time. In these embodiments, the online automated billing system 108 sends the total actual revenue amounts for triggering events for billing that are received during each interval for an advertising campaign.

As mentioned above, in one or more embodiments, the online automated billing system 108 sends billing information (e.g., actual revenue amounts) to the digital exploit management system 102 based on the timestamp of the online auction. Additional disclosure regarding various timelines and time periods for providing actual revenue amounts is provided below in the later figures.

As shown in FIG. 2A, the digital exploit management system 102 determines 216 that the advertising campaign is an exploit campaign. For instance, the digital exploit management system 102 determines that the displaced value for the advertising campaign exceeds the corresponding actual revenue. More specifically, the online automated billing system 108 determines that the displaced value for the advertising campaign exceeds the amount of actual revenue for the advertising campaign by an exploit threshold for a specific time period.

To illustrate, in one or more embodiments, the digital exploit management system 102 obtains both the displaced value and the actual revenue for an advertisement and/or an advertising campaign, as previously described. The digital exploit management system 102 then compares the displaced value to the actual revenue to determine whether the advertisement is performing as estimated, whether the advertisement is under performing (e.g., the displaced value is greater than the actual revenue), and/or whether the advertisement is part of an exploit campaign. In addition, as described in connection with FIG. 2B below, the digital exploit management system 102 can use additional analytics, factors, and safeguards to determine whether an advertisement is part of an exploit campaign or if there is another explanation for the advertisement's underperformance.

If the digital exploit management system 102 determines that an advertisement is underperforming, in some embodiments, the digital exploit management system 102 determines if the displaced value of the advertisement exceeds the actual revenue of the advertisement by an exploit threshold. In one or more embodiments, the exploit threshold is factor-based or multiplication-based, such as the displaced value being two times (2×), five times (5×), ten times (10×), twenty-five times (25×), or fifty times (50×), the actual revenue. In some embodiments, the exploit threshold is percentage based, such as the actual revenue being a percentage (e.g., 10%, 20%, or 50%) of the displaced value. In various embodiments, the exploit factor is a set monetary value, such as the displaced value being $100, $500, or $1,000 greater than the actual revenue. The set monetary value can be an hourly, daily, or lifetime amount.

As part of determining whether the advertisement is part of an exploit campaign, in one or more embodiments, the digital exploit management system 102 identifies a time period to compare displaced value to actual revenue for the advertisement. For example, the digital exploit management system 102 can analyze performance of winning bids for a one-hour time period to compare displaced value and actual revenue. The time period can be based on the online auction time, the impression time, and/or the billed time. For example, in one or more embodiments, the digital exploit management system 102 analyzes winning bids secured within a one-hour online auction time. In such circumstances, the digital exploit management system 102 sorts the actual revenue amounts for the advertisement based on when the auction for the advertisement occurred to determine an actual revenue amount corresponding to the winning bids.

In addition, in some embodiments, the digital exploit management system 102 waits a buffer or monitoring time period (i.e., a second time period) beyond the initial time period (e.g., a first time period) for additional billing information to arrive. For instance, some types of triggering events for billing (e.g., clicks, video views, downloads, or “likes”) take longer amounts of time between the online auction and the triggering event for billing. Thus, even if the online auction for an advertisement occurs in a first time period, the online automated billing system 108 may not receive an indication of the triggering event for billing until after the first time period is over. Thus, the digital exploit management system 102 increases the accuracy of determining whether the advertisement is part of an exploit campaign by waiting a second period of time after the first time period finishes.

In some embodiments, the digital exploit management system 102 determines a length of the second time period. For instance, the digital exploit management system 102 can select the second time period based on the type of triggering event for billing. For example, if the triggering event for billing for an advertisement is an impression, then the length of time from an advertisement winning an impression opportunity at the online auction to the online automated billing system 108 receiving an indication of the impression at the client device(s) 112 can occur in a few seconds. Accordingly, in such circumstances, the digital exploit management system 102 may select a second time period of a few second or minutes if the triggering event for billing is an impression.

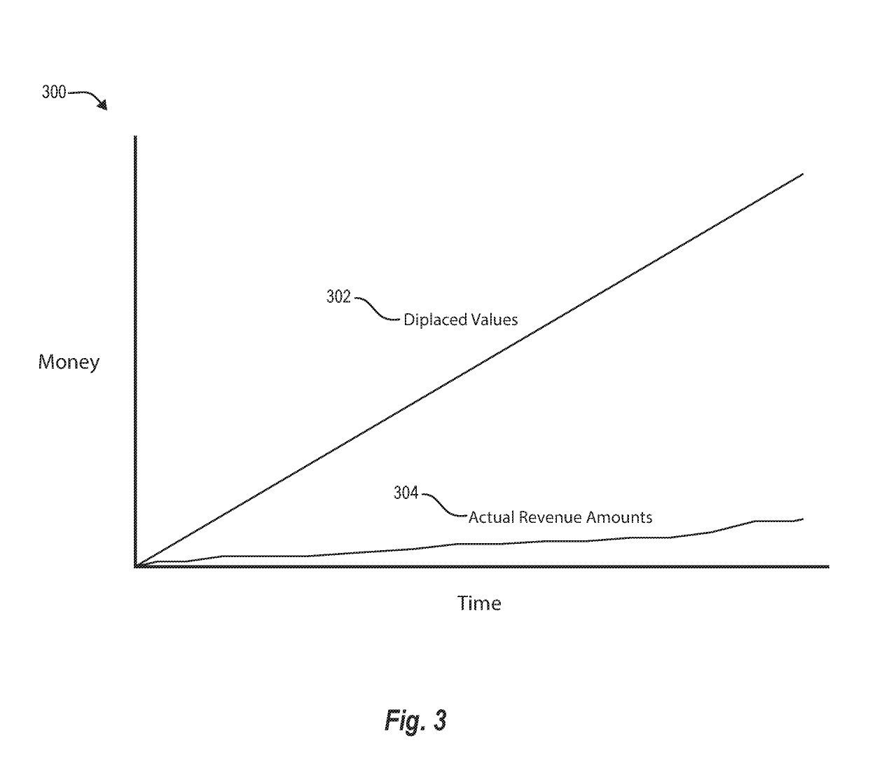

In another example, if the triggering event for billing is an application download and installation (which takes a longer period of time), the digital exploit management system 102 may select a longer second time period (e.g., thirty-minutes to an hour). Alternatively, the second time period may be a default amount of time that is configurable by a system administrator and/or advertiser. Additional description with respect to time periods for determining displaced value and actual revenue is provided below in connection with FIG. 4 below.

As shown in FIG. 2A, based on the advertisement being part of an exploit campaign, the digital exploit management system 102 throttles 218 future service of the advertising campaign. For instance, the digital exploit management system 102 throttles future service of advertisement(s) from the advertising campaign. As shown, the digital exploit management system 102 can utilize the online automated auction system 106, the online automated billing system 108, the digital advertising campaign system 104, and/or the client device(s) 112 to throttle an advertising campaign.

For example, in one or more embodiments, the digital exploit management system 102 throttles the advertising campaign by modifying campaign parameters (and resending the modified campaign parameters to the online automated auction system 106). For instance, the digital exploit management system 102 adjusts campaign parameters to reduce a bid value, narrow a target audience, lower budgets, and/or change a campaign objective (e.g., lower a target amount of impressions). In this manner, bids generated from the modified campaign parameters become less favorable compared to bids from other advertising campaigns and limit placement of future advertisements associated with the advertisement campaign.

In some embodiments, the digital exploit management system 102 throttles the advertising campaign at the online automated auction system 106. For instance, the digital exploit management system 102 can throttle an advertising campaign by modifying campaign parameters to re-award winning bids. For example, the digital exploit management system 102 can modify campaign parameters to limit the number of winning bids that the online automated auction system 106 can award. For example, the digital exploit management system 102 can determine that an advertising campaign has received a winning bid, but block (in accordance with modified campaign parameters) placement of an advertisement and re-award the winning bid to another advertiser (e.g., the second highest bidder). More specifically, the digital exploit management system 102 can throttle an advertising campaign by blocking placement (and re-awarding) a set amount (10%, 50%, or 90%) of advertisements. In this manner, the digital exploit management system 102 serves as a gatekeeper to ensure that a particular advertisement or advertisements from a particular advertising campaign are placed less frequently to client devices.

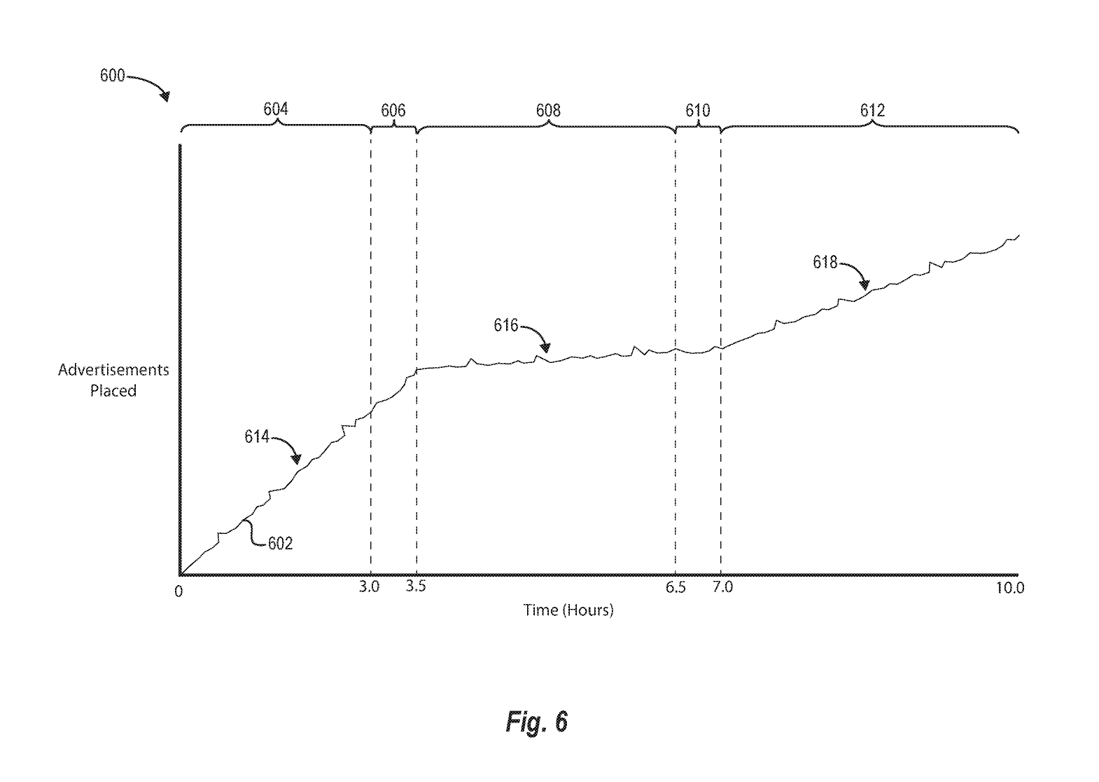

By throttling service of the advertising campaign, the digital exploit management system 102 can continue monitoring activity of the advertising campaign. Moreover, the digital exploit management system 102 can modify (or remove) throttling based on the monitored activity. For example, if the performance of the advertising campaign improves (e.g., it appears that vulnerability has been resolved because the gap between displaced value and actual revenue amounts improves), the digital exploit management system 102 can remove or reduce throttling (e.g., by restoring campaign parameters to original values). Alternatively, if performance does not improve (e.g., the gap between displaced value and actual revenue amounts grows or stays the same), the digital exploit management system 102 can further increase the amount of throttling to the advertising campaign to further prevent loss. Additional description regarding the digital exploit management system 102 continuously monitoring an advertising campaign to determine when to automatically throttle and un-throttle the advertising campaign is provided below with respect to FIG. 6.

As mentioned above, FIG. 2B illustrates additional analytics, factors, and safeguards to determine whether an advertisement is part of an exploit campaign (or if the discrepancy between the displaced value and the actual revenue is caused by another reason). In particular, FIG. 2B shows potential additional sub-actions that correspond to the action of determining 216 that the advertising campaign is an exploit campaign, as shown in FIG. 2A.

To illustrate, in one or more embodiments, the act of determining 216 that the advertising campaign is an exploit further includes verifying 216a that impressions are being properly served. Indeed, if an advertisement service error (i.e., “communication fault”) is occurring that prohibits an advertisement from being placed to a client device, the actual revenue amount for the advertisement can plummet relative to displaced value (through no fault of an advertiser or an advertising campaign).

As just mentioned, a communication fault (e.g., advertisement service error) prevents an advertisement from being served or reported back. For example, in some instances, the digital advertising campaign system 104 filters out advertisements that violate privacy settings resulting in a front-end invalidation (i.e., the advertisement is not served to client devices). While the digital advertising campaign system 104 may correctly filter out improper advertisements, in some circumstances, the digital advertising campaign system 104 filters out the advertisement after the online automated auction forum, resulting in a winning bid without a corresponding placement. Similarly, in other circumstances, the digital advertising campaign system 104 properly serves the advertisement to the client device(s) 112, but a communication fault prevents the client device(s) 112 from reporting back the impression and/or a triggering event for billing. In such circumstances, the actual revenue amount will suffer relative to displaced value for an advertising campaign.

In light of these communication faults, in one or more embodiments, the digital exploit management system 102 analyzes impressions to verify that the advertisement is actually served to the client device(s) 112. For instance, for advertising campaigns where the triggering event for billing is not an impression, using an impression count can verify that the advertisement is being served and reported back to the digital advertising campaign system 104.

To illustrate, in one or more embodiments, the digital exploit management system 102 determines (e.g., either directly or via the online automated auction system 106) a number of estimated impressions at the time of the online auction. In addition, the digital exploit management system 102 determines the number of counted impressions for the advertisement and/or advertising campaign. Using the estimated number of impressions and the number of counted impressions (e.g., for a specified time period), the digital exploit management system 102 can verify whether impressions are being properly served or whether there is a communication fault. For example, if the number of estimated impressions and the number of counted impressions are within a service threshold (e.g., 2×, 20%, or 100 impressions), the digital exploit management system 102 determines that no communication fault exists and that an advertising campaign is an exploit campaign when the displaced value exceeds the actual revenue by the exploit threshold.

Similarly, FIG. 2B also shows that the act of determining 216 that the advertising campaign is an exploit can further include determining 216b whether to adjust the displaced value based on a communication fault. For instance, as mentioned above, a communication fault may prevent impressions from being properly served. If a communication fault is preventing the advertisement from serving or reporting back, then the displaced value may not be an accurate instrument to determine whether the advertising campaign is an exploit campaign.

When a communication fault (e.g., advertisement service error) is detected, in one or more embodiments, the digital exploit management system 102 adjusts (e.g., depreciates) the displaced value to better reflect the number of advertisements that are being served for an advertising campaign. Indeed, the digital exploit management system 102 can determine a service error depreciation value to apply to the displaced value. For example, if only 50 out of 100 advertisements are being served (e.g., counted as impressions on client devices), then the digital exploit management system 102 can determine a service error depreciation value of 50% and apply the service error depreciation value to the displaced value, which reduces the displaced value by half. After adjusting the displaced value, the digital exploit management system 102 can then determine whether the displaced value exceeds the actual revenue for an advertising campaign. In another example, the digital exploit management system 102 reduces the displaced value based on the type of communication fault detected.

By adjusting the displaced value upon detecting a communication fault, the digital exploit management system 102 avoids unnecessarily penalizing an advertiser for the communication fault by throttling the advertiser's campaign. In addition, by adjusting the displaced value upon detecting a communication fault, the digital exploit management system 102 can still detect when an advertising campaign is an exploit campaign rather than stopping the advertising campaign completely or letting the advertising campaign continue to run as a potential exploit campaign.

In one or more embodiments, the digital exploit management system 102 also notifies a system administrator that a communication fault is present such that the communication fault can be resolved. If the digital exploit management system 102 detects a communication fault with one advertising campaign, it is possible that other advertising campaigns will have the same or similar communication faults.

As shown in FIG. 2B, the act of determining 216 that the advertising campaign is an exploit campaign can further include confirming 216c that the displaced value satisfies a minimum displaced value. In particular, if the displaced value falls below the minimum displaced, in one or more embodiments, the digital exploit management system 102 will not throttle an advertising campaign (i.e., will not undergo acts for determining that an advertising campaign is an exploit campaign).

For example, in one or more embodiments, the digital exploit management system will only throttle an advertising campaign where the displaced value exceeds $100. Thus, even where the relative difference between an actual revenue amount (e.g., $0.20) and a displaced value (e.g., $5.00) satisfies an exploit threshold (e.g., 50×), the revenue amounts are so minimal that the discrepancy may be a result of other factors. Moreover, utilizing this approach can increase processing efficiency (avoiding calculations of minor deficiencies that tax computing resources). Thus, the digital exploit management system 102 can employ a minimum displaced value as part of determining whether an advertising campaign is an exploit campaign.

In one or more embodiments, the minimum displaced value is a default amount (e.g., $10, $50, or $100). Moreover, in some embodiments, the minimum displaced value is an amount over a time period (e.g., the same time period as the displaced value and the actual revenue amount). For instance, the minimum displaced value can include a time-based amount (e.g., $10, $50, or $100 per hour or per day) that can be adjusted based on the length of the time period used to estimate the displaced value for an advertising campaign. Further, in some embodiments, the minimum displaced value can vary based on whether an advertisement is being served at a peak time or via a preferred communication medium.

It will be appreciated that the acts described in relation to FIGS. 2A-2B are intended to be illustrative of acts in accordance with the present disclosure, and are not intended to limit potential embodiments. Alternative embodiments can include additional, fewer, or different acts than those articulated in FIGS. 2A-2B. For example, as mentioned above, after throttling 218 future service of the advertising campaign, the digital exploit management system 102 can also un-throttle an advertising campaign.

Additionally, the acts described herein may be performed in a different order, may be repeated or performed in parallel with one another, or may be performed in parallel with different instances of the same or similar acts. For example, although FIG. 2A illustrates the online automated billing system 108 performing the act 213 of determining actual revenue, in one or more embodiments, the online automated billing system 108 sends billing information (e.g., triggering events, billing events, or other information that indicates an advertiser will be billed) to the digital advertising campaign system 104, and the digital advertising campaign system 104 performs the act 213 of determining actual revenue based on the billing information.

Moreover, although FIG. 2A illustrates particular components performing specific acts, the digital exploit management system 102 can utilize different components to perform the acts described herein. For example, although FIG. 2A illustrates the online automated auction system 106 determining 208 displaced value of winning bids, in some embodiments, the online automated auction system 106 provides information to the digital advertising campaign system 104 (or online automated billing system 108), which determines the displaced value for the advertising campaign. In sum, the digital exploit management system can perform the acts 202-218 illustrated in relation to FIG. 2A utilizing the online automated auction system 106, the online automated billing system 108, the digital advertising campaign system 104, and/or the client device(s) 112.

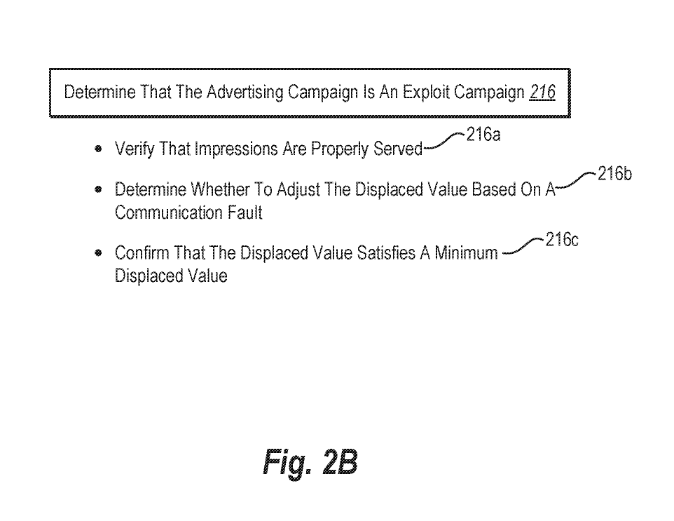

Turning now to FIGS. 3-6, graphical results and examples of the digital exploit management system 102 will be described. For instance, FIG. 3 illustrates an example graph 300 of displaced values 302 and actual revenue amounts 304 for an exploit campaign over time, in accordance with one or more embodiments. As shown, the graph 300 includes an x-axis corresponding to time and ay-axis corresponding to money. In addition, the graph 300 shows the discrepancy over time between the displaced values 302 and the actual revenue amounts 304 for an advertising campaign that is an exploit campaign.

As mentioned above, the digital exploit management system 102 can determine that an advertising campaign is an exploit campaign when the displaced value exceeds the actual revenue by an exploit threshold. As mentioned above, the exploit threshold can comprise a value, a multiplier, a percentage or some other comparative threshold. For instance, in some embodiments, the exploit threshold is exceeded when the displaced value is a multiple (e.g., 10× or 50×) of the actual revenue for the advertising campaign for a time period. In relation to FIG. 3, the displaced values 302 are approximately 50× greater than the actual revenue amounts 304 for the advertising campaign. For example, although not labeled, the displaced value is $250 at a point on the displaced values 302 and the actual revenue amount for a corresponding point in time on the actual revenue amounts 304 is $5.

In many instances, when an advertising campaign is an exploit campaign, the actual revenue is $0. In these cases, the digital exploit management system 102 can use a default amount as the actual revenue amount, such as $0.10, $0.01, or a fraction of a cent. Alternatively, when the actual revenue amount is zero, the digital exploit management system 102 determines that an advertising campaign is an exploit campaign when the displaced value is above a predetermined value (e.g., $100, $250 or $1,000).

While the digital exploit management system 102 can employ any type of exploit threshold, choosing a larger exploit threshold enables the digital exploit management system 102 to avoid falsely throttling a non-exploit campaign (i.e., false positives, which can irritate advertisers and result in reduced revenue). For instance, an advertising campaign may be poorly performing because it targets the wrong target audience. Rather than immediately determining that the advertising campaign is an exploit campaign because the actual revenue does not meet the displaced value, the digital exploit management system 102 provides a large tolerance to the advertising campaign. However, if the advertising campaign does exceed the exploit threshold, the digital exploit management system 102 can determine with a high confidence level that the advertising campaign is an exploit campaign.

While FIG. 3 shows that the displaced values 302 increase linearly over time, in alternative embodiments, the slope of the displaced values 302 may vary based on a number of factors. For example, if the advertising campaign runs on a schedule, the displaced value for the advertising campaign can increase more rapidly when the advertising campaign is scheduled to run. In another example, the displaced values 302 may rise faster during peak-times than in off-peak times. In other examples, the displaced values 302 may have a steeper slope when the advertising campaign is behind schedule.

The digital exploit management system 102 can monitor displaced values and actual revenue amounts over time (and at a variety of different times) to determine exploit campaigns. Thus, as the displaced value increases or decreases over a period of time, the digital exploit management system 102 can dynamically analyze corresponding actual revenue amounts to identify an exploit campaign.

For instance, FIG. 4 illustrates an example timeline 400 of a monitored time period 406 for an advertising campaign in accordance with one or more embodiments. As mentioned above, the digital exploit management system 102 can determine whether an advertising campaign is an exploit campaign by dynamically analyzing one or more time periods. Further, to ensure full and accurate reporting for the time period, the digital exploit management system 102 can utilize a buffer period to ensure the accuracy of identified exploit campaigns.

As illustrated, the timeline 400 includes a first time period 402 and a second time period 404 that together make up a monitored time period 406. For explanation purposes, the timeline 400 is shown in hours, although the timeline 400 can represent another unit of time (e.g., minutes or even seconds). Further, while the first time period 402 is 3-hours and the second time period 404 is 30-minutes, other durations of time are possible. For example, the duration of the first time period 402 can be 15-minutes, 30-minutes or an hour. In other examples, the duration of the second time period 404 can be a percentage of the first time period 402 (e.g., 10%, 15%, or 30%). In another example, the duration of the second time period 404 is based on the type of advertising campaign/triggering event for billing being used (e.g., where triggering events for billing that require more user interaction and/or time are longer than triggering events for billing that require less user interaction and/or time). Overall, the duration of the second time period 404 is such that most, if not all, triggering events for billing that correspond to winning bids in the first time period 402 will be reported.

The following example uses the timeline 400 to describe how the digital exploit management system 102 determines whether an advertising campaign is an exploit campaign, in accordance with one or more embodiments. Initially, the digital exploit management system 102 determines a displaced value for an advertising campaign based on bids that the advertising campaign wins at online auction for the first time period 402. For example, each time the advertising campaign wins a bid during the first time period 402, an online automated auction system 106 estimates the displaced value for the advertising campaign. As the advertising campaign wins more bids, the estimated value of the displaced value increases. The online automated auction system 106 can send the displaced value to the digital exploit management system 102 (e.g., after each winning bid, at regular intervals such as every 30-minutes, or at the end of the first time period 402).

Because the displaced value is estimated at the time of online auction bids during the first time period 402, the digital exploit management system 102 can obtain the final displaced value for the advertising campaign for the first time period 402 as soon as the first time period 402 concludes. Unlike the displaced value, if the digital advertising management system calculates actual revenue amounts of the advertising campaign at the end of the first time period 402 (e.g., at 3.0 hours), the digital exploit management system 102 risks not considering actual revenue amounts from winning bids that occur in the first time period 402 but that are not immediately acted upon or reported.

For instance, as mentioned above, for advertising campaigns that have impressions as a triggering event for billing, the second time period 404 can have a very brief span (e.g., a few seconds). Other types of advertising campaigns can require more time from the online auction to a triggering event for billing. Regardless of the precise length of time, however, as shown in FIG. 4, the digital exploit management system 102 waits the monitored time period 406 to allow additional triggering events for billing corresponding to winning bids in the first time period 402 to be reported or determined (e.g., via the online automated billing system 108).

Indeed, as mentioned above, the digital exploit management system can utilize online automated billing system 108 to determine and provide actual revenue amounts for an advertising campaign. Accordingly, at the end of the monitored time period 406, the digital exploit management system 102 can determine the actual revenue for served advertisements from the advertising campaign that correspond to winning bids during the first time period 402.

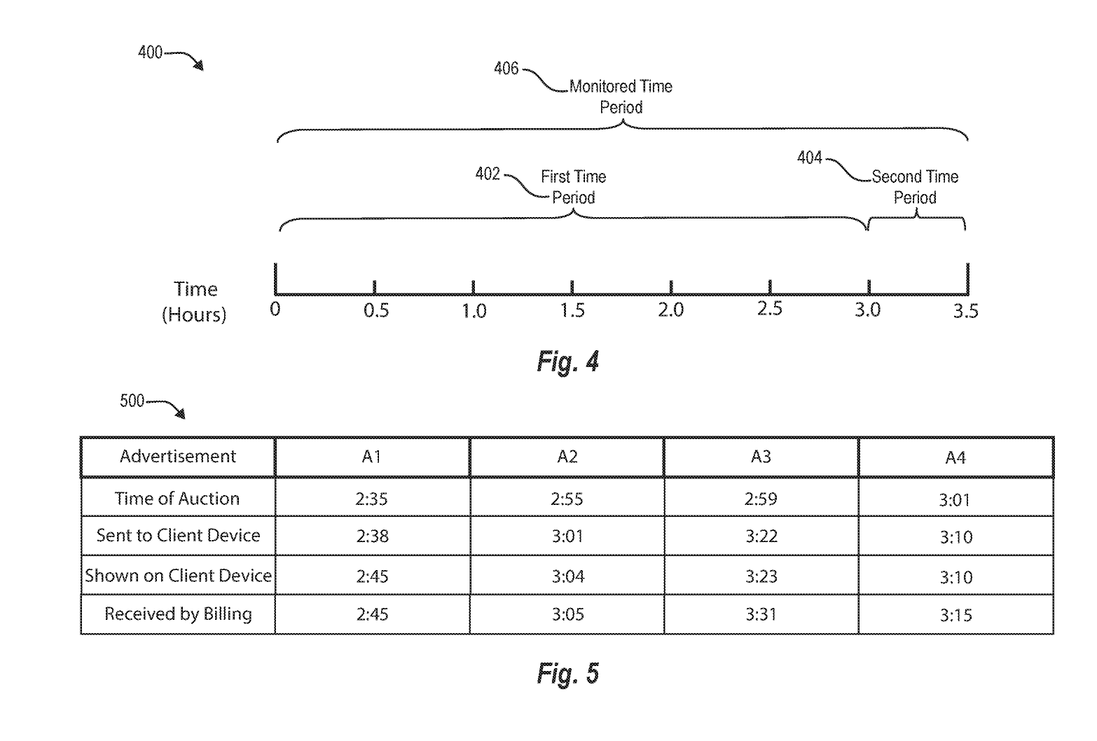

To further explain, FIG. 5 illustrates an example table 500 that displays timestamps associated with advertisement events from multiple advertisements in accordance with one or more embodiments. As shown in FIG. 5, the table includes various timestamps for a first advertisement (i.e., “A1”), a second advertisement (i.e., “A2”), a third advertisement (i.e., “A3”), and a fourth advertisement (i.e., “A4”) from a single advertising campaign. In addition, the timestamps of each event in the table 500 correspond to the timeline 400 shown in FIG. 4. Thus, timestamps between 0-3.0 hours are within the first time period 402, timestamps between 3.0-3.5 hours are within the second time period 404, and timestamps after 3.5 hours are outside of the monitoring period 406.

As mentioned above, the digital exploit management system 102 determines a displaced value for winning bids obtained within the first time period 402 (i.e., 0-3.0 hours). The digital exploit management system 102 can analyze the table 500 to identify which revenue amounts for which advertisements should be utilized to determine whether an advertisement campaign is an exploit campaign. Specifically, the digital exploit management system 102 can determine what advertisements correspond to actual revenue amounts that will be compared to the displaced value to determine whether an advertisement campaign is an exploit campaign.

For example, as shown in FIG. 5, each event for the first advertisement Al, from the time of auction timestamp (i.e., “2:35”) to the received by billing timestamp (i.e., “2:50”), occurs within the first time period 402. The digital exploit management system 102 determines that the winning bid for the first advertisement A1 occurred within the first time period 402 and the actual revenue amounts 304 was also recorded in the first time period 402. Accordingly, the digital exploit management system 102 utilizes the actual revenue amount for the first advertisement A1 in a comparison to a displaced value for the advertisement A1 to determine whether the first advertisement A1 corresponds to an exploit campaign.

For the second advertisement A2, the time of auction time stamp (i.e., “2:38”) occurs within the first time period 402. As also shown, the digital exploit management system 102 determines that the second advertisement A2 corresponds to a billing timestamp (i.e., “3:05”) within the second time period 404. In particular, the winning bid for the first advertisement A2 occurred within the first time period 402 and an actual revenue amount was recorded within the second time period 404. Because the time of auction timestamp and the billing timestamp for the second advertisement A2 are within the monitored time period 406 (i.e., the first time period 402 and the second time period 404), the digital exploit management systems utilizes the actual revenue amount for the second advertisement A2 to determine whether the second advertisement A2 corresponds to an exploit campaign.

With respect to the third advertisement A3, the time of auction timestamp (i.e., “2:55”) also occurs within the first time period 402 (and thus, affects the displaced value for the advertising campaign). However, because the received by billing timestamp (i.e., “3:31”) does not occur within the monitored time period 406, the revenue from the third advertisement A3 is not considered part of the actual revenue amount for the first time period 402. Accordingly, in a few instances, such as the third advertisement A3, the advertisement affects the displaced value but not the actual revenue of the advertising campaign for the first time period 402.

For the fourth advertisement A4, none of the events occur within the first time period 402. Indeed, the digital exploit management system 102 determines that the winning bid corresponding to the fourth advertisement A4 occurred outside of the first time period 402 even though the received by billing timestamp (i.e., “3:15”) occurs within the monitored time period 406. Accordingly, the fourth advertisement A4 does not affect either the displaced value or the actual revenue amount for the advertising campaign when determining whether the advertising campaign is an exploit campaign.

As shown in FIG. 5, the table 500 maintains timestamps for events corresponding to each advertisement of the advertising campaign. The digital exploit management system 102 (e.g., via the digital advertising campaign system 104) can maintain an advertising campaign database that stores information for each advertising campaign, including the timestamps shown in the table 500. In additional or alternative embodiments, the advertising campaign database is stored elsewhere, such as on the online automated auction system 106, the online automated billing system 108, or a third-party server.

In one or more embodiments, each time an event corresponding to an advertisement from an advertising campaign occurs, the digital exploit management system 102 detects the event and records a time and an identifier for the advertisement (e.g., by sending the detected time and identifier to the advertising campaign database, which stores a timestamp corresponding to the event). To illustrate, at the time of the online auction for the first advertisement A1, the online automated auction system 106 sends the identifier of the first advertisement A1 and the time to the advertising campaign database. In addition, the client device(s) 112 and/or the digital advertising campaign system 104 reports when the first advertisement A1 was sent to the client device and/or shown in the client device by sending the identifier of the first advertisement A1 and time to the advertising campaign database. Next, when the online automated billing system 108 identifies a triggering event for billing for the first advertisement A1, the online automated billing system 108 sends an identifier for the first advertisement A1 to the advertising campaign database, which records the received by billing timestamp for the first advertisement A1. The digital exploit management system 102 can then use timestamps in the advertising campaign database to determine if an advertising campaign is an exploit campaign, as described above.

In some embodiments, the advertisement itself indicates the various timestamps of each event. For example, the first advertisement A1 can include metadata for each of the events shown in the table 500. Each time an event occurs, the digital exploit management system 102 can update metadata of the first advertisement A1 to include a corresponding timestamp. The digital exploit management system 102 can then use the timestamps to determine whether the advertising campaign is an exploit campaign. More specifically, as described above, the digital exploit management system 102 can use the timestamps to determine whether the advertisement corresponds to winning bids in a specific time period and influences the displaced value and actual revenue, as described above.

Although the description of FIGS. 4 and 5 discuss static time ranges (e.g., a single monitored time period 406), the digital exploit management system 102 can dynamically analyze displaced value and actual revenue amounts over time to determine whether an advertising campaign is an exploit campaign. For example, the digital exploit management system 102 can analyze campaign performance at a pre-determined frequency (e.g., every five minutes) to determine whether an advertising campaign is an exploit campaign.

Furthermore, the digital exploit management system 102 can also simultaneously analyze multiple periods of time for an advertising campaign to determine whether the advertising campaign is an exploit campaign. For example, the digital exploit management system 102 can utilize a first monitored time period of 3.5 hours (e.g., 3.0 hours and 0.5 hours) to determine a first indicator of whether a first displaced value exceeds a first actual revenue amount by an exploit threshold. The digital exploit management system 102 can also utilize a second monitored time period of 1 hour (e.g., 0.75 hours and 0.25 hours) to determine a second indicator whether a second displaced value exceeds an actual revenue amount by a second exploit threshold. Moreover, the digital exploit management system 102 can utilize a third monitored time period of 15 minutes (e.g., 12 minutes and three minutes) to determine a third indicator of whether a third displaced value exceeds a third actual revenue amount by an exploit threshold. The digital exploit management system 102 can utilizes all three indicators to determine whether an advertising campaign is an exploit campaign (e.g., if at least two of the three indicators indicate that the advertising campaign is an exploit campaign).

As mentioned above in one or more embodiments, the digital exploit management system 102 can also un-throttle an advertising campaign. For example, FIG. 6 illustrates an example graph 600 of detecting, throttling, and un-throttling an advertising campaign 602 in accordance with one or more embodiments. As shown, the graph 600 includes advertisement placed along the y-axis and time along the x-axis. In particular, the x-axis shows a first time period 604, a second time period 606, a third time period 608, a fourth time period 610, and a fifth time period 612. The time periods for this particular example correspond to the time period discussed above in relation to FIG. 4. For example, the first time period 604 is 3-hours and the second time period 606 is 30-minutes (i.e., 3.0-3.5 hours). Likewise, the third time period 608 and the fifth time period 612 are 3 hours while the fourth time period is 30-minutes.

To illustrate, based on monitoring the advertising campaign 602 for the first time period 604 and the second time period 606 (e.g., a first monitored time period), the digital exploit management system 102 determines that the advertising campaign 602 is an exploit campaign. As shown, because the digital exploit management system 102 waits for the second time period to finish before making the determination, the first rate 614 (i.e., slope) of the advertising campaign 602 remains unchanged until the end of the second time period 606 (i.e., at 3.5 hours).

In response to determining that the advertising campaign 602 is an exploit campaign, the digital exploit management system 102 (at the end of the second time period 606) throttles the advertising campaign 602, as described above, for at least the third time period 608. The result of throttling the advertising campaign 602 is that fewer advertisements from the campaign are placed to client devices. As shown in the graph 600 of FIG. 6, the second rate 616 (i.e., slope) of the advertising campaign 602 is reduced (i.e., number of advertising placements increases more slowly than the first rate 614).

As shown, the digital exploit management system 102 continues to monitor the advertising campaign 602 for a second monitored time period, which includes the third time period 608 and the fourth time period 610. Similar to the first time period 604 and the second time period 606, to determine whether the advertising campaign 602 is still an exploit campaign for the third time period 608, the digital exploit management system 102 waits until the third time period 608 and the fourth time period 610 conclude.

At the end of the second monitored time period (e.g., the third time period 608 and the fourth time period 610), the digital exploit management system 102 determines that the advertising campaign 602 is no longer an exploit campaign. For example, the digital exploit management system 102 determines that the advertising campaign 602 had atypical results during the first time period and was not a true exploit campaign. Alternatively, the digital exploit management system 102 determines that the harmful effects of the advertising campaign 602 have been reduced (e.g., either automatically, or manually by the advertiser or another entity). Accordingly, the digital exploit management system 102 un-throttles or decreases the amount of throttling for the advertising campaign 602 during the next time period (i.e., the fifth time period 612).

As illustrated, the third rate 618 for the advertising campaign 602 during the fifth time period 612 is less steep than the first rate 614, but greater than the second rate 616. For instance, the third rate 618 indicates that the digital exploit management system 102 decreases the amount of throttling for the advertising campaign 602. Alternatively, if the digital exploit management system 102 un-throttles the advertising campaign 602, the third rate 618 can reflect the true rate of the advertising campaign 602 (further establishing that the first rate 614 was an atypical result).

Overall, as shown in FIG. 6, the digital exploit management system 102 can continuously monitor the advertising campaign 602 to throttle, un-throttle, and modify throttling of an advertising campaign. In this manner, the digital exploit management system 102 automatically restricts exploit campaigns without human intervention. In addition, the digital exploit management system 102 can automatically un-throttle or otherwise change campaign parameters of an advertising campaign to ensure that an advertising campaign is performing at an optimal level while participating equitably with other advertising campaigns.

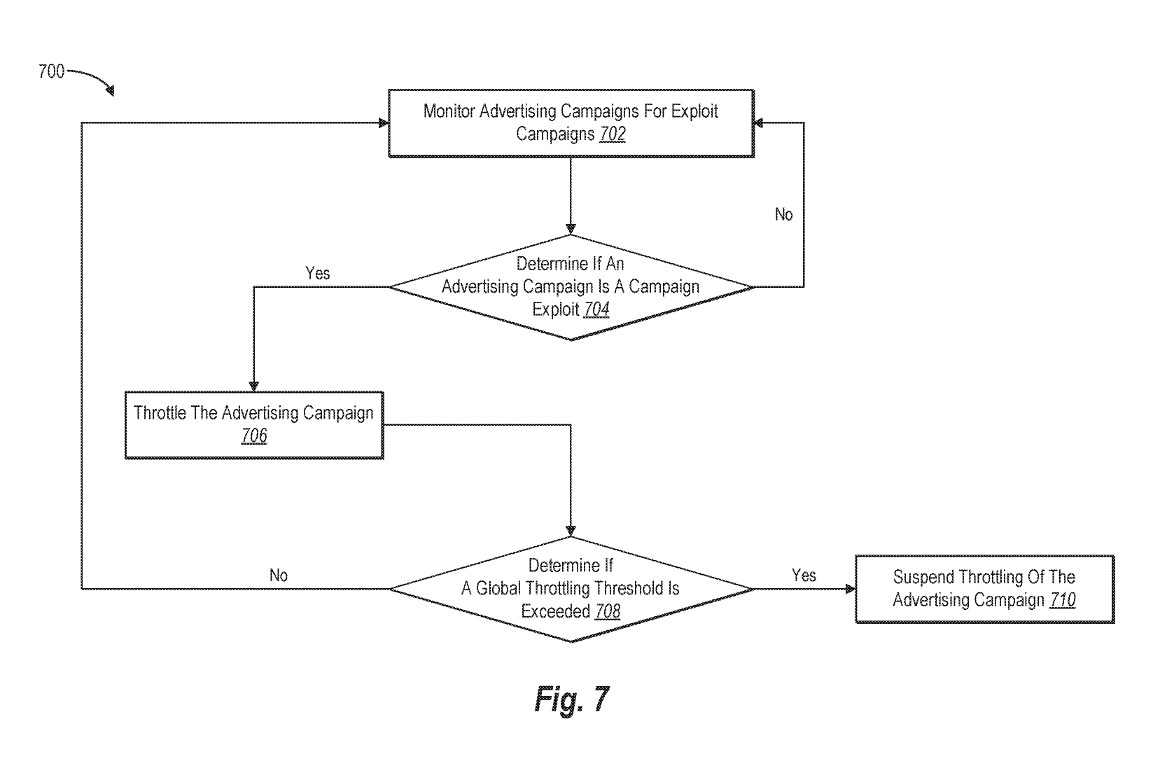

Turning now to FIG. 7, additional description is provided with respect to a global throttling threshold. To illustrate, FIG. 7 shows a flow diagram 700 of employing throttling safeguards in a digital advertising exploit detection system in accordance with one or more embodiments of the digital exploit management system 102. In one or more embodiments, the digital exploit management system 102 performs the acts 702-710 shown in the flow diagram 700 via the online automated auction system 106, the online automated billing system 108, and/or the digital advertising campaign system 104. In alternative embodiments, another server or device performs the illustrated actions.

As illustrated, the digital exploit management system 102 monitors 702 advertising campaigns for exploit campaigns. For instance, the digital exploit management system 102 serves advertisement that corresponds to winning bids via an online auction and determines actual revenue amounts corresponding to those served advertisements.

As part of monitoring advertising campaigns, the digital exploit management system 102 can determine 704 if an advertising campaign is an exploit campaign. As described above, the digital exploit management system 102 can determine that an advertising campaign is an exploit campaign when the displaced value for a time period exceeds the actual revenue for the same time period by an exploit threshold. If the digital exploit management system 102 determines that the advertising campaign is not an exploit campaign (i.e., “No”), the digital exploit management system 102 returns to monitoring 702 advertising campaigns for exploit campaigns, as shown in FIG. 7.

If the digital exploit management system 102 determines that the advertising campaign is an exploit campaign (i.e., “Yes”), the digital exploit management system 102 throttles the advertising campaign 706. As described and shown above, throttling the advertising campaign can include modifying one or more of the campaign parameters of the exploit campaign to reduce the number of winning bids for the advertising campaign for a period of time.

In addition, FIG. 7 shows the digital exploit management system 102 also determining 708 if a global threshold is exceeded. To explain, each time the digital exploit management system 102 throttles an advertising campaign, the digital exploit management system 102 checks to see if a global threshold is exceeded. In some embodiments, the global threshold indicates that the total number of advertising campaigns currently being throttled is too high and that a fault exists within the digital exploit management system 102 and/or another server associated with serving and reporting advertisements.

To illustrate, in some instances, the global threshold can be a percentage of all advertising campaigns currently being executed (e.g., 5%, 10%, or 20%). In other instances, the global threshold is a set number (e.g., 500, 1,000, or 10,000). When the global threshold is satisfied or exceeded, a signal is provided to the digital exploit management system 102 that a coding fault or bug may be present in the digital exploit management system 102. For instance, while exploitive advertisers exist, the number of these exploitive advertisers is typically small. Thus, if the digital exploit management system 102 begins throttling too many advertising campaigns, either the digital exploit management system 102 may have a fault that is causing it to falsely identify exploit campaign, or other faults (e.g., programming bugs) are present that enable too many advertising campaigns to execute exploit campaigns.

Thus, as shown in FIG. 7, if the digital exploit management system 102 determines that the global threshold is not exceeded (i.e., “No”), the digital exploit management system 102 returns to monitoring 702 advertising campaigns for exploit campaigns. Otherwise (i.e., “Yes”), the digital exploit management system 102 suspends 710 throttling of the advertising campaign. In addition, the digital exploit management system 102 can suspend throttling of other advertising campaigns (e.g., all advertising campaigns being throttled).

As mentioned above, exceeding the global threshold may signal an issue with either the digital exploit management system 102 or another server associated with serving and reporting advertisements. Thus, if there is a system-wide issue, the digital exploit management system 102 can automatically pause throttling to prevent further loss of revenue due to a fault or bug. This feature is especially beneficial when a large number of programmers or employees are modifying code that could introduce faults or bugs to an advertising platform.

In addition, while not illustrated, the digital exploit management system 102 can also notify a system administrator or programmer of the digital exploit management system 102 that the global threshold is being exceeded and that throttling is being suspended for at least the advertising campaign. In this manner, the system administrator can take the appropriate actions to remedy any fault, bug, or issue that is causing the global threshold to be exceeded. Alternatively, the system administrator can instruct the digital exploit management system 102 to resume throttling the advertising campaign and/or other advertising campaigns that are deemed exploit campaigns.

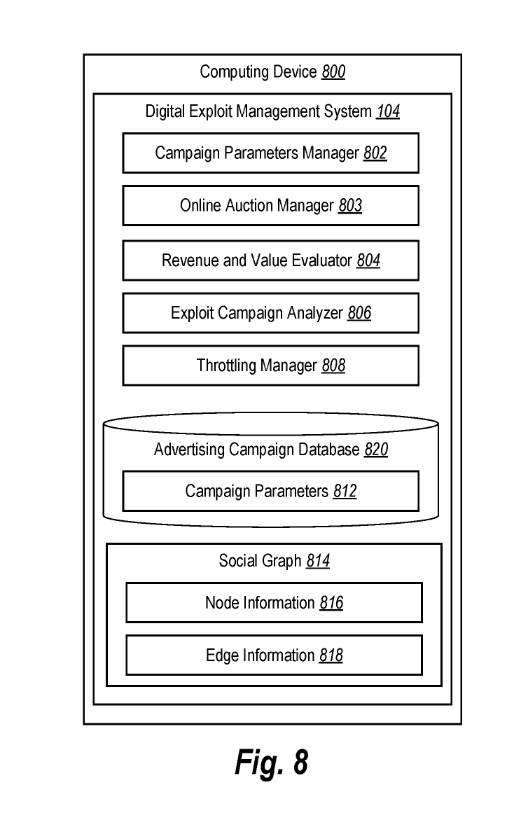

FIG. 8 illustrates a schematic diagram of the digital exploit management system 102 in accordance with one or more embodiments. As shown, the digital exploit management system 102 is implemented via a computing device 800. The computing device 800 can comprise a server, such as the server(s) 101 (and/or servers corresponding to the digital advertising campaign system 104, the online automated auction system 106, the online automated billing system 108) or another server device. In some embodiments, the computing device 800 comprises a client device. Additional description regarding computing devices is provided below with respect to FIG. 10.

As shown, the computing device 800 includes the digital exploit management system 102. The digital exploit management system 102 includes a campaign parameters manager 802, an online auction manager 803, a revenue and value evaluator 804, an exploit campaign analyzer 806, a throttling manager 808, an advertising campaign database 820 (comprising campaign parameters 812), and a social graph 814 (comprising node information 816 and edge information 818). Although illustrated together, the components shown in the computing device 800 can be joined or divided in a variety of configurations.

The digital exploit management system 102 as shown includes the campaign parameters manager 802. In general, the campaign parameters manager 802 receives, stores, analyzes, modifies, and/or provides campaign parameters. For example, in one or more embodiments, the campaign parameters manager 802 communicates with an advertiser via an advertiser device to receive and modify campaign parameters. In some embodiments, the campaign parameters manager 802 provides campaign parameters to an online automated auction server, as described above. Further, the campaign parameters manager 802 can communicate with the throttling manager 808 to adjust campaign parameters, as described below.

In one or more embodiments, the campaign parameters manager 802 stores campaign parameters within the advertising campaign database 820 (e.g., campaign parameters 812). As mentioned above, campaign parameters 812 can define the objective, budget, scope, and duration of the advertising campaign. For instance, campaign parameters 812 include the objective of the advertising campaign (e.g., traffic, exposure, impressions, clicks, downloads, lead generations, shares, app installs, video views, conversions, or sales), costs the advertiser is willing to spend on an advertising campaign (e.g., daily budget and lifetime budgets), bidding preferences, targeting parameters, the duration and schedule of the campaign, and/or the reach of the campaign, the communications channel on which to advertise (e.g., websites, search results, social networks, mobile applications, or multiple channels), billing preferences (e.g., how much and how often to bill), and advertisements to include in the advertising campaign (e.g., text, images, and video).

In addition, the digital exploit management system 102 includes the online auction manager 803. In general, the online auction manager 803 facilitates online automated auctions. For example, the online auction manager 803 creates bids for an advertising campaign of an advertiser based on the campaign parameters associated with the advertising campaign, as previously described. In addition, the online auction manager 803 identifies impression opportunities and creates a forum where advertisers bid against each other to win the impression opportunities, as described above.

The digital exploit management system 102 also includes the revenue and value evaluator 804. In general, the revenue and value evaluator 804 determines the displaced value and the actual revenue for an advertising campaign (e.g., one or more advertisements). For instance, in one or more embodiments, the revenue and value evaluator 804 determines the displaced value for an advertising campaign for a first time period.

In addition, in one or more embodiments, the revenue and value evaluator 804 determines an actual revenue amount (e.g., an actual revenue amount for the advertising campaign for the same time period corresponding to winning bids for the advertising campaign during the first period. In additional embodiments, the revenue and value evaluator 804 waits for an additional time period (e.g., a second time period) for billing information to be received before determining the actual revenue amount for the advertising campaign for the first time period, as described above. Further, the revenue and value evaluator 804 can adjust the displaced value based on detecting communication faults (e.g., service error) with respect to serving and reporting advertisements of an advertising campaign, as described previously.

The exploit campaign analyzer 806, in general, can determine whether an advertising campaign is an exploit campaign. For instance, the exploit campaign analyzer 806 can analyze the displaced value and the actual revenue for an advertising campaign for one or more periods of time. In particular, the exploit campaign analyzer 806 can analyze whether the displaced value exceeds the actual revenue by an exploit threshold, as previously described. Further, the exploit campaign analyzer 806 can continuously monitor an exploit campaign to determine if further actions are required (e.g., apply heavier throttling, lighter throttling, or no-throttling).

The throttling manager 808 can throttle an advertising campaign that is deemed an exploit campaign. For example, in one or more embodiments, the throttling manager 808 communicates with the campaign parameters manager 802 to modify the campaign parameters 812 of an advertising campaign, which results in limiting at least one placement of a future advertisement from the advertising campaign.

As shown, the digital exploit management system 104 includes the social graph 814, which includes node information 816 and edge information 818. The social graph 814 can include node information 816 that stores information comprising nodes for users, nodes for concepts, and/or nodes for content items. In addition, the social graph 814 can include edge information 818 comprising relationships between nodes and/or actions occurring within the social-networking system. Further detail regarding social-networking systems, social graphs, edges, and nodes is presented below.

The digital exploit management system 102 can communicate with the social graph 814 to perform its functions. For example, the digital exploit management system 102 can utilize the social graph 814 to obtain impression opportunities and provide advertisements. For instance, the digital exploit management system 102 can obtain user information that includes specific details regarding the user to whom an advertisement is to be placed. Accordingly, the digital exploit management system 102 can use the received information to match targeting parameters in conducting an online auction. In addition, the digital exploit management system 102 can place advertisements from various advertising campaigns utilizing the social graph 814 (e.g., within a social networking news feed). For example, the digital exploit management system 102 can provide an advertisement to the social graph 814 for a user where the advertisement corresponds to a winning bid for an impression opportunity.

In one or more embodiments, the components 802-820 of the computing device 800 can comprise software, hardware, or both. For example, the components 802-820 can comprise one or more instructions stored on a computer-readable storage medium and executable by processors of one or more computing devices. When executed by the one or more processors, the computer-executable instructions of the digital exploit management system 102 can cause the computing device 800 to perform the methods described herein. Alternatively, the components 802-820 and their corresponding elements can comprise hardware, such as a special purpose processing device to perform a certain function or group of functions. Additionally, the components 802-820 can comprise a combination of computer-executable instructions and hardware.

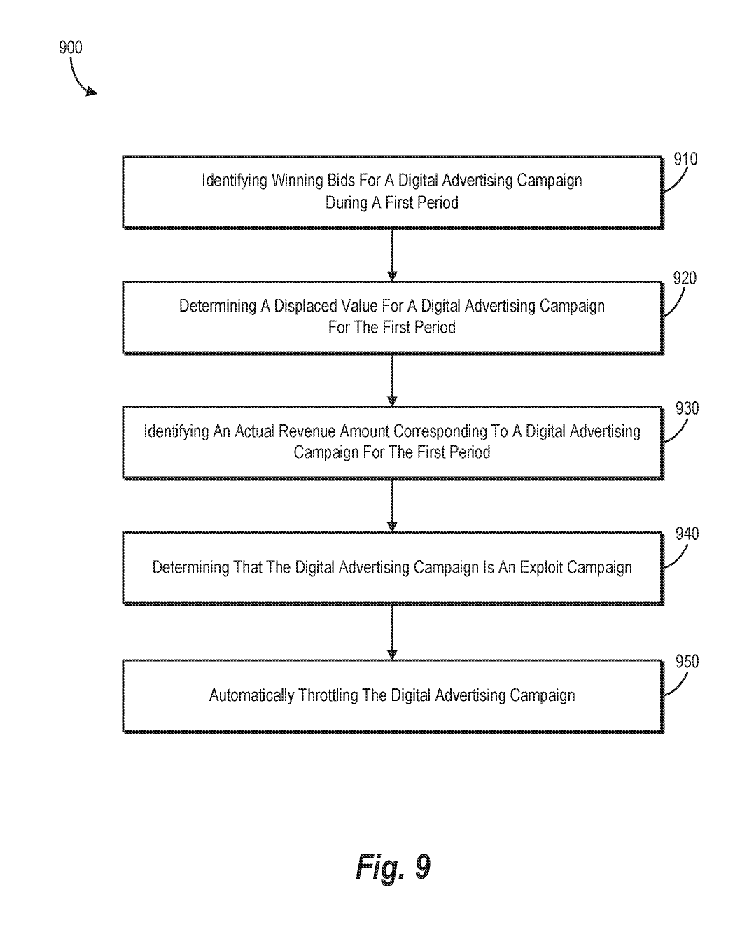

FIGS. 1-8, the corresponding text, and the examples provide a number of different methods, systems, devices, and non-transitory computer readable media for detecting and curing exploit campaigns. In addition to the foregoing, one or more embodiments can also be described in terms of flowcharts comprising acts in a method for accomplishing a particular result. For example, FIG. 9 may be performed with more or fewer acts. Further, the acts may be performed in differing orders. Additionally, the acts described herein may be repeated or performed in parallel with one another or in parallel with different instances of the same or similar acts.

As mentioned, FIG. 9 illustrates a flowchart of a series of acts 900 of automatically throttling an exploit campaign in accordance with one or more embodiments. While FIG. 9 illustrates acts according to one embodiment, alternative embodiments may omit, add to, reorder, and/or modify any of the acts shown in FIG. 9. The acts of FIG. 9 can be performed as part of a method. Alternatively, a non-transitory computer readable medium can comprise instructions, that when executed by one or more processors, cause a computing device to perform the acts of FIG. 9. In some embodiments, a system can perform the acts of FIG. 9.

The series of acts 900 includes an act 910 of identifying winning bids for a digital advertising campaign during a first period. In particular, the act 910 may involve identifying, by running a real-time and online automated auction forum for impression opportunities, winning bids for a digital advertising campaign of an advertiser during a first time period, where the digital advertising campaign includes campaign parameters.

The series of acts 900 also includes an act 920 of determining a displaced value for a digital advertising campaign for the first period. In particular, the act 920 may involve determining, during execution of the digital advertising campaign, a displaced value for the first time period, where the displaced value includes a predicted amount of revenue from the digital advertising campaign corresponding to the winning bids during the first time period.

In addition, the series of acts 900 includes an act 930 of identifying an actual revenue amount corresponding to a digital advertising campaign for the first period. In particular, the act 930 may involve identifying an actual revenue amount associated with the advertiser corresponding to the winning bids during the first time period. In one or more embodiments, the act 930 includes identifying the actual revenue amount during the first time period and a second time period, where the second time period is a predetermined amount of time, and where the first time period and the second time period define a monitored time period.

The series of acts 900 also includes an act 940 of determining that the digital advertising campaign is an exploit campaign. In particular, the act 940 may involve determining that the digital advertising campaign is an exploit campaign based on the displaced value, the actual revenue amount, and an exploit threshold. In some embodiments, the act 940 also includes determining that the displaced value exceeds the actual revenue amount associated with the advertiser corresponding to the winning bids by at least the exploit threshold. In some embodiments, the exploit threshold is a multiple of the actual revenue amount (e.g., 10× or 50×).

Additionally, the series of acts 900 includes an act 950 of automatically throttling the digital advertising campaign. In particular, the act 950 may involve automatically throttling the digital advertising campaign based on determining that the digital advertising campaign is an exploit campaign. In one or more embodiments, the act 950 further includes automatically throttling the digital advertising campaign by modifying one or more of the campaign parameters to limit placement of at least one future advertisement from the digital advertising campaign.

The series of acts 900 can also include one or more additional acts. For example, the series of acts 900 includes the acts of providing, based on identifying the digital advertising campaign winning bids at the online automated auction forum during the first time period, an advertisement of the digital advertising campaign to one or more client devices via an online media channel; receiving a first indication that the advertisement of the digital advertising campaign was served to a client device, where the first indication includes a served to client device timestamp and a time of auction timestamp; and receiving a second indication from an automated billing forum indicating the actual revenue amount corresponding to the digital advertising campaign. In additional embodiments, the series of acts 900 includes receiving the first indication during the monitored time period; determining, based on the time of auction timestamp, that the advertisement of the digital advertising campaign corresponds to a winning bid during the first time period; and determining, based on the served to client device timestamp, that the advertisement of the digital advertising campaign was served to the client device during the first time period.

As another example, the series of acts 900 includes the acts of executing the digital advertising campaign during a third time period; determining, for the third time period, that the digital advertising campaign is not an exploit campaign; and based on determining that the digital advertising campaign is not an exploit campaign during the third time period, automatically un-throttling the digital advertising campaign by modifying one or more of the campaign parameters to increase future winning bids associated with the digital advertising campaign. In some embodiments, the second time period is shorter than the first time period and the third time period is after the second time period.

The series of acts 900 can further include the acts of estimating, for the first time period, an estimated number of impressions for the digital advertising campaign; and identifying, during the monitored time period, an actual number of impressions corresponding to the digital advertising campaign being served on one or more client devices, where the actual number of impressions correspond to the winning bids during the first time period, and where determining that the digital advertising campaign is an exploit campaign is further based on comparing the estimated number of impressions for the digital advertising campaign to the actual number of impressions for the digital advertising campaign for the first time period. In one or more embodiments, comparing the estimated number of impressions of the digital advertising campaign includes determining that the estimated number of impressions for the digital advertising campaign is within an impression threshold of the actual number of impressions for the digital advertising campaign for the first time period.

In one or more embodiments, the series of acts 900 includes the act of throttling a plurality of digital advertising campaigns; determining that throttling the plurality of digital advertising campaigns exceeds a global throttling threshold; and un-throttling the digital advertising campaign based on the determination that throttling the plurality of digital advertising campaigns exceeds the global throttling threshold. In some embodiments, the series of acts 900 includes the act of determining that the displaced value satisfies a minimum displaced value threshold, where throttling the digital advertising campaign is further based on the determination that the displaced value satisfies the minimum displaced value threshold.

In various embodiments, the series of acts 900 includes the acts of detecting, during the first time period, a service error with serving an advertisement of the digital advertising campaign to one or more client devices; estimating a service error depreciation value based on the service error; and reducing the displaced value by the service error depreciation value before determining that the digital advertising campaign is an exploit campaign.

Embodiments of the present disclosure may comprise or utilize a special purpose or general-purpose computer including computer hardware, such as, for example, one or more processors and system memory, as discussed in greater detail below. Embodiments within the scope of the present disclosure also include physical and other computer-readable media for carrying or storing computer-executable instructions and/or data structures. In particular, one or more of the processes described herein may be implemented at least in part as instructions embodied in a non-transitory computer-readable medium and executable by one or more computing devices (e.g., any of the media content access devices described herein). In general, a processor (e.g., a microprocessor) receives instructions, from a non-transitory computer-readable medium, (e.g., a memory, etc.), and executes those instructions, thereby performing one or more processes, including one or more of the processes described herein.

Computer-readable media can be any available media that can be accessed by a general purpose or special purpose computer system. Computer-readable media that store computer-executable instructions are non-transitory computer-readable storage media (devices). Computer-readable media that carry computer-executable instructions are transmission media. Thus, by way of example, and not limitation, embodiments of the disclosure can comprise at least two distinctly different kinds of computer-readable media: non-transitory computer-readable storage media (devices) and transmission media.

Non-transitory computer-readable storage media (devices) includes RAM, ROM, EEPROM, CD-ROM, solid state drives (“SSDs”) (e.g., based on RAM), Flash memory, phase-change memory (“PCM”), other types of memory, other optical disk storage, magnetic disk storage or other magnetic storage devices, or any other medium which can be used to store desired program code means in the form of computer-executable instructions or data structures and which can be accessed by a general purpose or special purpose computer.

A “network” is defined as one or more data links that enable the transport of electronic data between computer systems and/or modules and/or other electronic devices. When information is transferred or provided over a network or another communications connection (either hardwired, wireless, or a combination of hardwired or wireless) to a computer, the computer properly views the connection as a transmission medium. Transmissions media can include a network and/or data links which can be used to carry desired program code means in the form of computer-executable instructions or data structures and which can be accessed by a general purpose or special purpose computer. Combinations of the above should also be included within the scope of computer-readable media.

Further, upon reaching various computer system components, program code means in the form of computer-executable instructions or data structures can be transferred automatically from transmission media to non-transitory computer-readable storage media (devices) (or vice versa). For example, computer-executable instructions or data structures received over a network or data link can be buffered in RAM within a network interface module (e.g., a “NIC”), and then eventually transferred to computer system RAM and/or to less volatile computer storage media (devices) at a computer system. Thus, it should be understood that non-transitory computer-readable storage media (devices) can be included in computer system components that also (or even primarily) utilize transmission media.

Computer-executable instructions comprise, for example, instructions and data which, when executed at a processor, cause a general-purpose computer, special purpose computer, or special purpose processing device to perform a certain function or group of functions. In some embodiments, computer-executable instructions are executed on a general-purpose computer to turn the general-purpose computer into a special purpose computer implementing elements of the disclosure. The computer executable instructions may be, for example, binaries, intermediate format instructions such as assembly language, or even source code. Although the subject matter has been described in language specific to structural features and/or methodological acts, it is to be understood that the subject matter defined in the appended claims is not necessarily limited to the described features or acts described above. Rather, the described features and acts are disclosed as example forms of implementing the claims.

Those skilled in the art will appreciate that the disclosure may be practiced in network computing environments with many types of computer system configurations, including, personal computers, desktop computers, laptop computers, message processors, hand-held devices, multi-processor systems, microprocessor-based or programmable consumer electronics, network PCs, minicomputers, mainframe computers, mobile telephones, PDAs, tablets, pagers, routers, switches, and the like. The disclosure may also be practiced in distributed system environments where local and remote computer systems, which are linked (either by hardwired data links, wireless data links, or by a combination of hardwired and wireless data links) through a network, both perform tasks. In a distributed system environment, program modules may be located in both local and remote memory storage devices.

Embodiments of the present disclosure can also be implemented in cloud computing environments. In this description, “cloud computing” is defined as a model for enabling on-demand network access to a shared pool of configurable computing resources. For example, cloud computing can be employed in the marketplace to offer ubiquitous and convenient on-demand access to the shared pool of configurable computing resources. The shared pool of configurable computing resources can be rapidly provisioned via virtualization and released with low management effort or service provider interaction, and then scaled accordingly.

A cloud-computing model can be composed of various characteristics such as, for example, on-demand self-service, broad network access, resource pooling, rapid elasticity, measured service, and so forth. A cloud-computing model can also expose various service models, such as, for example, Software as a Service (“SaaS”), Platform as a Service (“PaaS”), and Infrastructure as a Service (“IaaS”). A cloud-computing model can also be deployed using different deployment models such as private cloud, community cloud, public cloud, hybrid cloud, and so forth. In this description and in the claims, a “cloud-computing environment” is an environment in which cloud computing is employed.

FIG. 10 illustrates a block diagram of exemplary computing device 1000 that may be configured to perform one or more of the processes described above. One will appreciate that the computing device 1000 may represent one or more client devices or server devices, such as those described previously mentioned (e.g., 101, 110, 112, and 800). Further, the computing device 1000 may represent various types of computing devices. For example, the computing device 1000 can include: a mobile device such as a mobile telephone, a smartphone, a PDA, a tablet, a laptop; a non-mobile device such as a desktop or server; or any other type of computing device.

As shown by FIG. 10, the computing device 1000 can comprise a processor 1002, a memory 1004, a storage device 1006, an input/output (“I/O”) interface 1008, and a communication interface 1010, which may be communicatively coupled by way of a communication infrastructure 1012. While an exemplary computing device 1000 is shown in FIG. 10, the components illustrated in FIG. 10 are not intended to be limiting. Additional or alternative components may be used in other embodiments. Furthermore, in certain embodiments, the computing device 1000 can include fewer components than those shown in FIG. 10.

In one or more embodiments, the processor 1002 includes hardware for executing instructions, such as those making up a computer program. The memory 1004 may be used for storing data, metadata, and programs for execution by the processor(s). The storage device 1006 includes storage for storing data or instructions.

The I/O interface 1008 allows a user (e.g., content producer or viewer) to provide input to, receive output from, and otherwise transfer data to and receive data from computing device 1000. The I/O interface 1008 may include a mouse, a keypad or a keyboard, a touchscreen, a camera, an optical scanner, network interface, modem, other known I/O devices or a combination of such I/O interfaces. The I/O interface 1008 may also include one or more devices for presenting output to a user, including, but not limited to, a graphics engine, a display (e.g., a display screen), one or more output drivers (e.g., display drivers), one or more audio speakers, and one or more audio drivers. In certain embodiments, the I/O interface 1008 is configured to provide graphical data to a display for presentation to a user. The graphical data may be representative of one or more graphical user interfaces and/or any other graphical content as may serve a particular implementation.

The communication interface 1010 can include hardware, software, or both. In any event, the communication interface 1010 can provide one or more interfaces for communication (such as, for example, packet-based communication) between the computing device 1000 and one or more other computing devices or networks. As an example, the communication interface 1010 may include a network interface controller (NIC) or network adapter for communicating with an Ethernet or other wire-based network or a wireless NIC (WNIC) or wireless adapter for communicating with a wireless network, such as a WI-FI. The communication infrastructure 1012 may include hardware, software, or both that connects components of the computing device 1000 to each other. As an example, the communication infrastructure 1012 may include one or more types of buses.

As mentioned above, the communications system can be included in a social networking system. A social networking system may enable its users (such as persons or organizations) to interact with the system and with each other. The social networking system may, with input from a user, create and store in the social networking system a user profile associated with the user. As described above, the user profile may include demographic information, communication channel information, and information on personal interests of the user.

In more detail, user profile information may include, for example, biographic information, demographic information, behavioral information, the social information, or other types of descriptive information, such as work experience, educational history, hobbies or preferences, interests, affinities, or location. Interest information may include interests related to one or more categories, which may be general or specific. As an example, if a user “likes” an article about a brand of shoes, the category may be the brand.

The social networking system may also, with input from a user, create and store a record of relationships of the user with other users of the social networking system, as well as provide services (e.g. wall posts, photo-sharing, online calendars and event organization, messaging, games, or advertisements) to facilitate social interaction between or among users. Also, the social networking system may allow users to post photographs and other multimedia content items to a user's profile page (typically known as “wall posts” or “timeline posts”) or in a photo album, both of which may be accessible to other users of the social networking system depending on the user's configured privacy settings. Herein, the term “friend” may refer to any other user of the social networking system with which a user has formed a connection, association, or relationship via the social networking system.

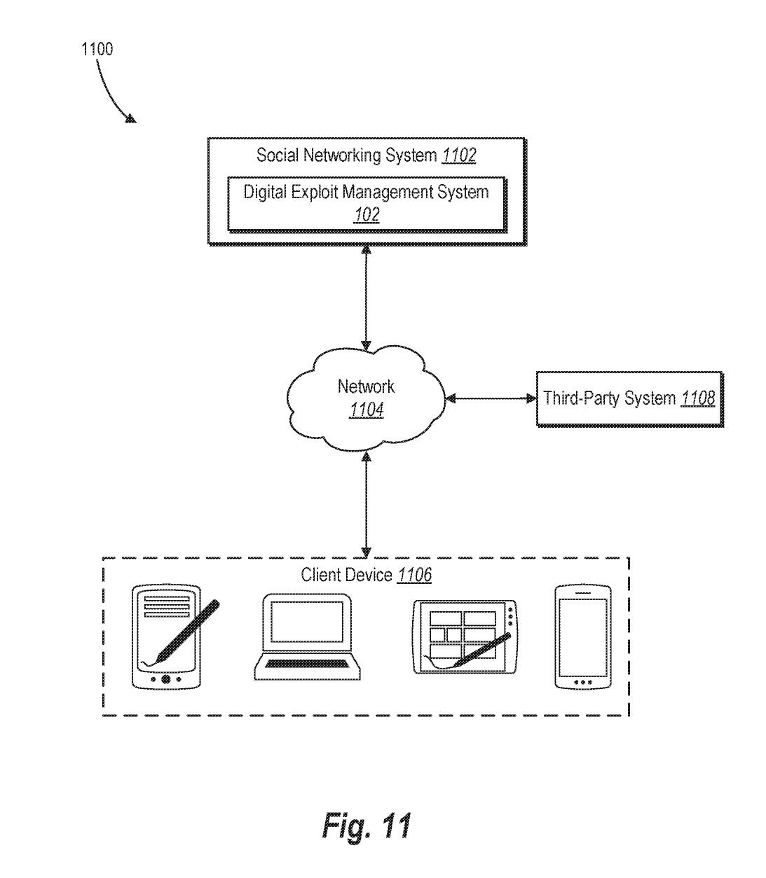

FIG. 11 illustrates an example network environment 1100 of a social networking system. The network environment 1100 includes a client device 1106, a social networking system 1102 comprising the digital exploit management system 102, and a third-party system 1108 connected to each other by a network 1104. Although FIG. 11 illustrates a particular arrangement of client device 1106, the social networking system 1102, the third-party system 1108, and the network 1104, this disclosure contemplates any suitable arrangement and number of client device 1106, the social networking system 1102, the third-party system 1108, and the network 1104.

Links may connect the client device 1106, the social networking system 1102, and the third-party system 1108 to the network 1104 or to each other. Links need not necessarily be the same throughout network environment 1100. One or more first links may differ in one or more respects from one or more second links.

In some embodiments, the client device 1106 may be an electronic device including hardware, software, or embedded logic components or a combination of two or more such components and capable of carrying out the appropriate functionalities implemented or supported by the client device 1106. As an example, a client device 1106 may include any of the computing devices discussed above in relation to FIG. 11. The client device 1106 may enable a network user at the client device 1106 to access the network 1104. The client device 1106 may enable its user to communicate with other users at other client devices or systems.

In some embodiments, the client device 1106 may include a web browser, such as and may have one or more add-ons, plug-ins, or other extensions. The client device 1106 may render a web page based on the HTML files from the server for presentation to the user.

In some embodiments, the social networking system 1102 may be a network-addressable computing system that can host an online social network. In addition, the social networking system 1102 may generate, store, receive, and send social-networking data, such as, for example, user-profile data, concept-profile data, the social-graph information, or other suitable data related to the online social network. The social networking system 1102 may be accessed by the other components of the network environment 1100 either directly or via the network 1104.

As shown, the social networking system 1102 includes the digital exploit management system 102, which is described above. The digital exploit management system 102 may be implemented on a unitary server or a distributed server spanning multiple computers or multiple datacenters. These servers may be of various types, such as, for example and without limitation, web server, news server, mail server, message server, advertising server, file server, application server, exchange server, database server, proxy server, etc., or any combination thereof.

In some embodiments, the social networking system 1102 may include one or more data stores. Data stores may be used to store various types of information. In some embodiments, the information stored in data stores may be organized according to specific data structures. Particular embodiments may provide interfaces that enable the client device 1106, the social networking system 1102, or the third-party system 1108 to manage, retrieve, modify, add, or delete, the information stored in data stores.

In some embodiments, the social networking system 1102 may store one or more social graph, described below. In one or more embodiments, the social networking system 1102 may provide users with the ability to take actions on various types of items or objects, supported by social networking system 1102. As an example, the items and objects may include groups or social networks to which users of the social networking system 1102 may belong, events or calendar entries in which a user might be interested, computer-based applications that a user may use, transactions that allow users to buy or sell items via the customer service, interactions with advertisements that a user may perform, etc. A user may also interact with anything that is capable of being represented in the social networking system 1102 or by an external system of the third-party system 1108, which is separate from the social networking system 1102 and coupled to the social networking system 1102 via the network 1104.

The social networking system 1102 can include a variety of stores, modules, and/or managers as described below. In one or more embodiments, a connection manager may be used for storing connection information about users. The connection information may indicate users who have similar or common work experience, group memberships, hobbies, educational history, or are in any way related or share common attributes. The connection information may also include user-defined connections between different users and content (both internal and external). An action-logging manager may be used to receive communications from a web server about a user's actions on or off the social networking system 1102. In conjunction with the action log, a third-party content object log may be maintained of user exposures to third-party content objects. An advertisement-pricing module may combine social information, the current time, location information, or other suitable information to provide relevant advertisements, in the form of notifications, to a user.

Authorization servers may be used to enforce one or more privacy settings of the users of the social networking system 1102. A privacy setting of a user determines how particular information associated with a user can be shared. The authorization server may allow users to opt in to or opt out of having their actions logged by the social networking system 1102 or shared with other systems (e.g., the third-party system 1108), such as, for example, by setting appropriate privacy settings.

In some embodiments, the third-party system 1108 may include one or more types of servers, one or more data stores, one or more interfaces, including but not limited to APIs, one or more web services, one or more content sources, one or more networks, or any other suitable components. The third-party system 1108 may be operated by a different entity from an entity operating the social networking system 1102 even if, in some embodiments, the social networking system 1102 and the third-party systems 1108 operate in conjunction with each other. In this sense, the social networking system 1102 may provide a platform, or backbone, which other systems, such as the third-party systems 1108, may use to provide social-networking services and functionality to users across the Internet.

In some embodiments, a third-party system 1108 may include a third-party content object provider. A third-party content object provider may include one or more sources of content objects, which may be communicated to the client device 1106. As an example, content objects may include information regarding things or activities of interest to the user. As another example, content objects may include incentive content objects.

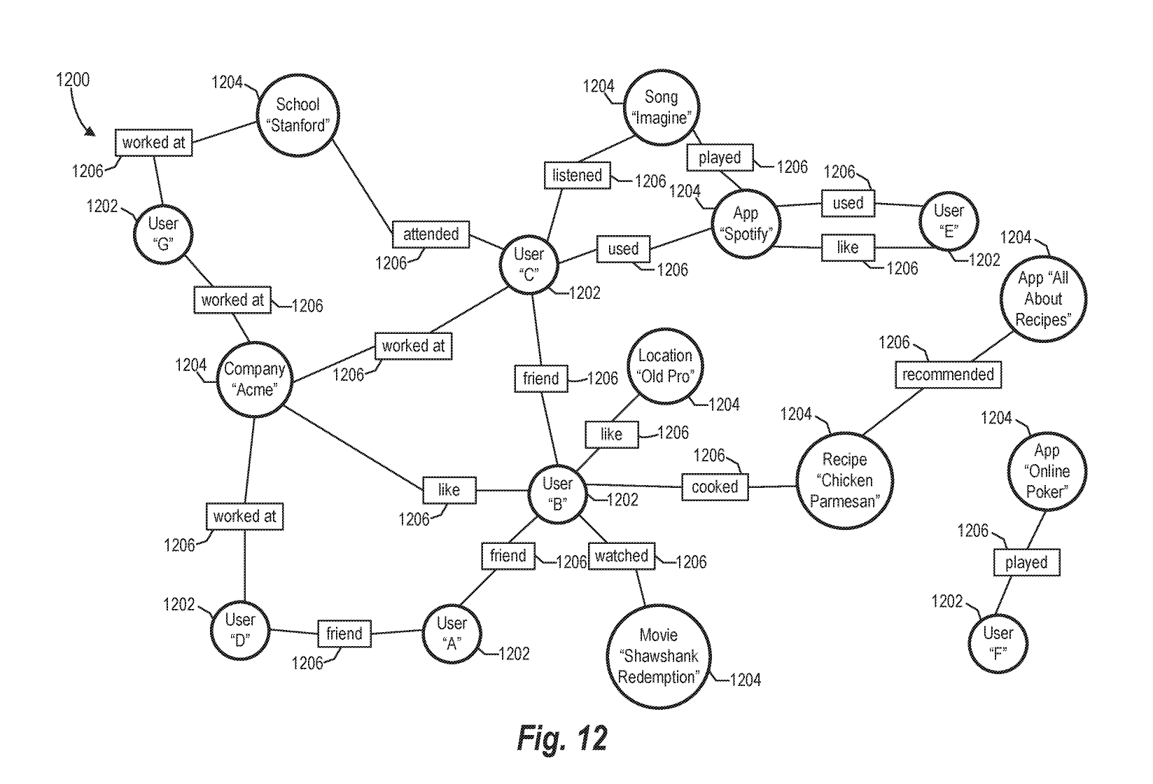

FIG. 12 illustrates an example social graph 1200. In some embodiments, the social networking system 1102 may store one or more social graphs 1200 in one or more data stores. In some embodiments, the social graph 1200 may include multiple nodes—which may include multiple user nodes or multiple concept nodes—and multiple edges 1206 connecting the nodes. The social graph 1200 illustrated in FIG. 12 is shown, for didactic purposes, in a two-dimensional visual map representation.

In some embodiments, a user node 1202 may correspond to a user of social networking system 1102. When a user registers for an account with social networking system 1102, the social networking system 1102 may create a user node 1202 corresponding to the user, and store the user node 1202 in one or more data stores. Users and user nodes described herein may, where appropriate, refer to registered users and user nodes associated with registered users.

In some embodiments, a concept node 1204 may correspond to a concept. As an example, a concept may correspond to a place, a website, an entity, a resource, etc. A concept may be located within social networking system 1102 or on an external server. A concept node 1204 may be associated with information of a concept provided by a user or information gathered by various systems, including the social networking system 1102.

In some embodiments, a node in social graph 1200 may represent or be represented by an online profile page. Profile pages may be hosted by or accessible to social networking system 1102. Profile pages may be viewable by all or a selected subset of other users. As an example, a user node 1202 may have a corresponding user-profile page where the corresponding user may add content, make declarations, or otherwise express him or herself. As another example, a concept node 1204 may have a corresponding concept-profile page in which one or more users may add content, make declarations, or express themselves, particularly in relation to the concept corresponding to concept node 1204.

As an example, an edge 1206 may represent a friendship, family relationship, business or employment relationship, fan relationship, follower relationship, visitor relationship, sub scriber relationship, superior/subordinate relationship, reciprocal relationship, non-reciprocal relationship, another suitable type of relationship, or two or more such relationships.

In some embodiments, a pair of nodes in social graph 1200 may be connected to each other by one or more edges 1206. An edge 1206 connecting a pair of nodes may represent a relationship between the pair of nodes. In some embodiments, an edge 1206 may include or represent one or more data objects or attributes corresponding to the relationship between a pair of nodes. As an example, a first user may indicate that a second user is a “friend” of the first user. In response to this indication, the social networking system 1102 may send a “friend request” to the second user. If the second user confirms the “friend request,” the social networking system 1102 may create an edge 1206 connecting the first user's user node 1202 to the second user's user node 1202 in social graph 1200 and store edge 1206 as social-graph information in one or more of data stores.

In some embodiments, an edge 1206 between a user node 1202 and a concept node 1204 may represent a particular action or activity performed by a user associated the with the user node 1202 toward a concept associated with the concept node 1204. As an example, as illustrated in FIG. 12, a user may “like,” “attended,” “played,” “listened,” “cooked,” “worked at,” or “watched” a concept, each of which may correspond to an edge type or subtype.

In some embodiments, the social networking system 1102, the client device 1106, or the third-party system 1108 may access the social graph 1200 and related social-graph information for suitable applications. The nodes and edges of social graph 1200 may be stored as data objects, for example, in a data store (such as a social-graph database). Such a data store may include one or more searchable or queryable indexes of nodes or edges of social graph 1200.

In some embodiments, an advertisement may be text (which may be HTML-linked), one or more images (which may be HTML-linked), one or more videos, audio, one or more ADOBE FLASH files, a suitable combination of these, or any other suitable advertisement in any suitable digital format presented on one or more web pages, in one or more e-mails, or in connection with search results requested by a user. In addition, or as an alternative, an advertisement may be one or more sponsored stories (e.g., a news feed or ticker item on the social networking system 1102).

An advertisement may also include social networking system functionality with which a user may interact. As an example, an advertisement may enable a user to “like” or otherwise endorse the advertisement by selecting an icon or link associated with an endorsement. In addition, or as an alternative, an advertisement may include social networking system context directed to the user. As an example, an advertisement may display information about a friend of the user within social networking system 1102 who has taken an action associated with the subject matter of the advertisement.

In some embodiments, the social networking system 1102 may determine the social-graph affinity (herein as “affinity”) of various social-graph entities for each other. Affinity may represent the strength of a relationship or level of interest between particular objects associated with the online social network, such as users, concepts, content, actions, advertisements, other objects associated with the online social network, or any suitable combination thereof. Affinity may also be determined with respect to objects associated with third-party systems 1108 or other suitable systems. An overall affinity for a social-graph entity for each user, subject matter, or type of content may be established. The overall affinity may change based on continued monitoring of the actions or relationships associated with the social-graph entity.

In some embodiments, the social networking system 1102 may measure or quantify social-graph affinity using an affinity coefficient (herein as “coefficient”). The coefficient may represent or quantify the strength of a relationship between particular objects associated with the online social network. The coefficient may also represent a probability or function that measures a predicted probability that a user will perform a particular action based on the user's interest in the action. In this way, a user's future actions may be predicted based on the user's prior actions, where the coefficient may be calculated at least in part on the history of the user's actions.

Coefficients may be used to predict any number of actions, which may be within or outside of the online social network. As an example, these actions may include various types of communications, such as sending messages, posting content, or commenting on content; various types of observation actions, such as accessing or viewing profile pages, media, or other suitable content; various types of coincidence information about two or more social-graph entities, such as purchasing a product from a merchant.

In some embodiments, the social networking system 1102 may use a variety of factors to calculate a coefficient. These factors may include, for example, user actions, types of relationships between objects, location information, other suitable factors, or any combination thereof. In some embodiments, different factors may be weighted differently when calculating the coefficient. The weights for each factor may be static, or the weights may change according to, for example, the user, the type of relationship, the type of action, the user's location, and so forth. Ratings for the factors may be combined according to their weights to determine an overall coefficient for the user.

To calculate the coefficient of a user towards a particular object, the rating assigned to the user's actions may comprise, for example, 60% of the overall coefficient, while the relationship between the user and the object may comprise 40% of the overall coefficient. In some embodiments, the social networking system 1102 may consider a variety of variables when determining weights for various factors used to calculate a coefficient, such as, for example, the time since information was accessed, decay factors, frequency of access, relationship to information or relationship to the object about which information was accessed, relationship to social-graph entities connected to the object, short- or long-term averages of user actions, user feedback, other suitable variables, or any combination thereof.

A coefficient may include a decay factor that causes the strength of the signal provided by particular actions to decay with time, such that actions that are more recent are more relevant when calculating the coefficient. The ratings and weights may be continuously updated based on continued tracking of the actions upon which the coefficient is based. Any process or algorithm may be employed for assigning, combining, averaging, and so forth the ratings for each factor and the weights assigned to the factors. In some embodiments, the social networking system 1102 may determine coefficients using machine-learning algorithms trained on historical actions and past user responses, or data farmed from users by exposing them to various options and measuring responses.

In some embodiments, the social networking system 1102 may calculate a coefficient based on a user's actions. The social networking system 1102 may monitor such actions on the online social network, on the third-party system 1108, on other suitable systems, or any combination thereof. Typical user actions include viewing profile pages, creating or posting content, interacting with content, joining groups, listing and confirming attendance at events, checking-in at locations, liking particular pages, creating pages, and performing other tasks that facilitate social action.

In some embodiments, the social networking system 1102 may calculate a coefficient based on the user's actions with particular types of content. The content may be associated with the online social network, the third-party system 1108, or another suitable system. The social networking system 1102 may analyze a user's actions to determine whether one or more of the actions indicate an affinity for subject matter, content, other users, and so forth.

In some embodiments, the social networking system 1102 may calculate a coefficient based on the type of relationship between particular objects. Referencing the social graph 1200, the social networking system 1102 may analyze the number and/or type of edges 1206 connecting particular user nodes and concept nodes 1204 when calculating a coefficient. As an example, depending upon the weights assigned to the actions and relationships for the particular user, the overall affinity may be determined to be higher for content about a user's spouse than for content about a user's friend.

In some embodiments, the coefficient may be based on the degree of separation between particular objects. The degree of separation between any two nodes is defined as the minimum number of hops needed to traverse the social graph from one node to the other. A degree of separation between two nodes can be considered a measure of relatedness between the users or the concepts represented by the two nodes in the social graph. For example, two users having user nodes that are directly connected by an edge (i.e., are first-degree nodes) may be described as “connected users” or “friends.” Similarly, two users having user nodes that are not connected directly, but are connected through another user node (i.e., are second-degree nodes) may be described as “friends of friends.” The lower coefficient may represent the decreasing likelihood that the first user will share an interest in content objects of the user that is indirectly connected to the first user in the social graph 1200.

In some embodiments, the social networking system 1102 may calculate a coefficient based on location information. Objects that are geographically closer to each other may be considered to be more related, or of more interest, to each other than more distant objects. In some embodiments, the coefficient of a user towards a particular object may be based on the proximity of the object's location to a current location associated with the user (or the location of a client device 1106 of the user). A first user may be more interested in other users or concepts that are closer to the first user. As an example, if a user is one mile from an airport and two miles from a gas station, the social networking system 1102 may determine that the user has a higher coefficient for the airport than the gas station based on the proximity of the airport to the user.

In some embodiments, the social networking system 1102 may perform particular actions with respect to a user based on the coefficient information. The coefficients may be used to predict whether a user will perform a particular action based on the user's interest in the action. A coefficient may be used when generating or presenting any type of objects to a user. The coefficient may also be utilized to rank and order such objects, as appropriate. In this way, the social networking system 1102 may provide information that is relevant to user's interests and current circumstances, increasing the likelihood that they will find such information of interest.

In some embodiments, the social networking system 1102 may generate search results based on the coefficient information. Search results for a particular user may be scored or ranked based on the coefficient associated with the search results with respect to the querying user. As an example, search results corresponding to objects with higher coefficients may be ranked higher on a search-results page than results corresponding to objects having lower coefficients.

In connection with social-graph affinity and affinity coefficients, particular embodiments may utilize one or more systems, components, elements, functions, methods, operations, or steps disclosed in U.S. patent application Ser. No. 11/503,093, filed Aug. 10, 2006, U.S. patent application Ser. No. 12/977,027, filed Dec. 22, 2010, U.S. patent application Ser. No. 12/978,265, filed Dec. 23, 2010, and U.S. patent application Ser. No. 13/632,869, filed Oct. 1, 2012, each of which is incorporated by reference in their entirety.

In some embodiments, one or more of the content objects of the online social network may be associated with a privacy setting. The privacy settings (or “access settings”) for an object may be stored in any suitable manner, such as, for example, in association with the object, in an index on an authorization server, in another suitable manner, or any combination thereof. A privacy setting of an object may specify how the object (or particular information associated with an object) can be accessed (e.g., viewed or shared) using the online social network. Where the privacy settings for an object allow a particular user to access that object, the object may be described as being “visible” with respect to that user. In some embodiments, privacy settings may be associated with particular social-graph elements. Privacy settings of a social-graph element, such as a node or an edge, may specify how the social-graph element, information associated with the social-graph element, or content objects associated with the social-graph element can be accessed using the online social network.

In some embodiments, one or more servers may be authorization/privacy servers for enforcing privacy settings. In response to a request from a user (or other entity) for a particular object stored in a data store, the social networking system 1102 may send a request to the data store for the object. The request may identify the user associated with the request and may be sent to the user (or the client device 1106 of the user) if the authorization server determines that the user is authorized to access the object based on the privacy settings associated with the object, but not otherwise.

The preceding specification is described with reference to specific exemplary embodiments thereof. The description above and drawings are illustrative and are not to be construed as limiting. The additional or alternative embodiments may be embodied in other specific forms without departing from its spirit or essential characteristics. The scope of the invention is, therefore, indicated by the appended claims rather than by the preceding description. All changes that come within the meaning and range of equivalency of the claims are to be embraced within their scope.

What is claimed is:

1. A method comprising:
identifying, by running a real-time, online automated auction forum for impression opportunities, winning bids for a digital advertising campaign of an advertiser during a first time period, wherein the digital advertising campaign comprises campaign parameters;
determining, during execution of the digital advertising campaign, a displaced value for the first time period, wherein the displaced value comprises a predicted amount of revenue from the digital advertising campaign corresponding to the winning bids during the first time period;
identifying an actual revenue amount associated with the advertiser corresponding to the winning bids during the first time period;
determining, by at least one processor, that the digital advertising campaign is an exploit campaign based on the displaced value, the actual revenue amount, and an exploit threshold; and
based on determining that the digital advertising campaign is an exploit campaign, automatically throttling the digital advertising campaign by modifying one or more campaign parameters of the campaign parameters to limit placement of at least one future advertisement from the digital advertising campaign.

2. The method of claim 1, wherein identifying the actual revenue amount associated with the advertiser corresponding to the winning bids during the first time period comprises identifying the actual revenue amount during the first time period and a second time period, wherein the second time period is a predetermined amount of time, and wherein the first time period and the second time period define a monitored time period.

3. The method of claim 2, wherein determining that the digital advertising campaign is an exploit campaign further comprises determining that the displaced value exceeds the actual revenue amount associated with the advertiser corresponding to the winning bids by at least the exploit threshold.

4. The method of claim 2, further comprising:
providing, based on identifying the winning bids at the online automated auction forum during the first time period, an advertisement of the digital advertising campaign to a client device via an online media channel;
receiving, during the second time period, an indication that the advertisement of the digital advertising campaign was served to the client device;
identifying an auction timestamp of the advertisement;
determining, based on the auction timestamp, that the advertisement of the digital advertising campaign corresponds to a winning bid of the winning bids during the first time period; and
based on receiving the indication during the second time period and determining that the advertisement corresponds to the winning bid during the first time period, utilizing an actual revenue corresponding to the advertisement to identify the actual revenue amount.

5. The method of claim 2, further comprising:
executing the digital advertising campaign with the modified one or more campaign parameters during a third time period;
determining, for the third time period, that the digital advertising campaign is not an exploit campaign; and
based on determining that the digital advertising campaign is not an exploit campaign during the third time period, automatically un-throttling the digital advertising campaign by modifying at least one campaign parameter to increase placement of future advertisements from the digital advertising campaign.

6. The method of claim 2, wherein the second time period is shorter than the first time period, and wherein the third time period is after the second time period.

7. The method of claim 2, further comprising:
determining, for the first time period, an estimated number of impressions for the digital advertising campaign;
identifying, during the monitored time period, an actual number of impressions corresponding to the digital advertising campaign being served on one or more client devices, wherein the actual number of impressions correspond to the winning bids during the first time period; and
wherein determining that the digital advertising campaign is an exploit campaign is further based on comparing the estimated number of impressions for the digital advertising campaign to the actual number of impressions for the digital advertising campaign.

8. The method of claim 1, further comprising:
throttling a plurality of digital advertising campaigns;
determining that throttling the plurality of digital advertising campaigns exceeds a global throttling threshold; and
un-throttling the digital advertising campaign based on the determination that throttling the plurality of digital advertising campaigns exceeds the global throttling threshold.

9. The method of claim 1, further comprising:
determining that the displaced value satisfies a minimum displaced value threshold; and
wherein throttling the digital advertising campaign is further based on the determination that the displaced value satisfies the minimum displaced value threshold.

10. A system comprising:
at least one processor; and
at least one non-transitory computer-readable storage medium storing instructions that, when executed by the at least one processor, cause the system to:
identify, by running a real-time, online automated auction forum for impression opportunities, winning bids for a digital advertising campaign of an advertiser during a first time period, wherein the digital advertising campaign comprises campaign parameters;
determine, during execution of the digital advertising campaign, a displaced value for the first time period, wherein the displaced value comprises a predicted amount of revenue from the digital advertising campaign corresponding to the winning bids during the first time period;
identify an actual revenue amount associated with the advertiser corresponding to the winning bids during the first time period;
determine that the digital advertising campaign is an exploit campaign based on the displaced value, the actual revenue amount, and an exploit threshold; and
based on determining that the digital advertising campaign is an exploit campaign, automatically throttle the digital advertising campaign by modifying one or more of the campaign parameters to limit placement of at least one future advertisement from the digital advertising campaign.

11. The system of claim 10, further comprising instructions that, when executed by the at least one processor, cause the system to:
throttle a plurality of digital advertising campaigns;
determine that throttling the plurality of digital advertising campaigns exceeds a global throttling threshold; and
un-throttle the digital advertising campaign based on the determination that throttling the plurality of digital advertising campaigns exceeds the global throttling threshold.

12. The system of claim 10, further comprising instructions that, when executed by the at least one processor, cause the system to:
determine that the displaced value satisfies a minimum displaced value threshold; and
wherein throttling the digital advertising campaign is further based on the determination that the displaced value satisfies the minimum displaced value threshold.

13. The system of claim 10, further comprising instructions that, when executed by the at least one processor, cause the system to:
detect, during the first time period, an advertisement service error with serving an advertisement of the digital advertising campaign to one or more client devices;
determine a service error depreciation value based on the advertisement service error; and
reduce the displaced value by the service error depreciation value before determining that the digital advertising campaign is an exploit campaign.

14. The system of claim 10, further comprising instructions that, when executed by the at least one processor, cause the system to identify the actual revenue amount associated with the advertiser corresponding to the winning bids during the first time period by identifying the actual revenue amount during the first time period and a second time period, wherein the second time period is a predetermined amount of time, and wherein the first time period and the second time period define a monitored time period.

15. The system of claim 14, further comprising instructions that, when executed by the at least one processor, cause the system to determine that the digital advertising campaign is an exploit campaign by determining that, during execution of the digital advertising campaign during the first time period, the displaced value exceeds the actual revenue amount associated with the advertiser corresponding to the winning bids by at least the exploit threshold.

16. The system of claim 14, further comprising instructions that, when executed by the at least one processor, cause the system to:
receive, during the second time period, an indication that the advertisement of the digital advertising campaign was served to the client device;
identify an auction timestamp of the advertisement;
determine, based on the auction timestamp, that the advertisement of the digital advertising campaign corresponds to a winning bid of the winning bids during the first time period; and
based on receiving the indication during the second time period and determining that the advertisement corresponds to the winning bid during the first time period, utilize an actual revenue corresponding to the advertisement to identify the actual revenue amount.

17. A non-transitory computer-readable medium storing instructions that, when executed by at least one processor, cause a computer system to:
identify, by running a real-time, online automated auction forum for impression opportunities, winning bids for a digital advertising campaign of an advertiser during a first time period, wherein the digital advertising campaign comprises campaign parameters;
determine, during execution of the digital advertising campaign, a displaced value for the first time period, wherein the displaced value comprises a predicted amount of revenue from the digital advertising campaign corresponding to the winning bids during the first time period;
identify an actual revenue amount associated with the advertiser corresponding to the winning bids during the first time period;
determine that the digital advertising campaign is an exploit campaign based on the displaced value, the actual revenue amount, and an exploit threshold; and
based on determining that the digital advertising campaign is an exploit campaign, automatically throttle the digital advertising campaign by modifying one or more of the campaign parameters to limit placement of at least one future advertisement from the digital advertising campaign.

18. The non-transitory computer-readable medium of claim 17, further storing instructions that, when executed by the at least one processor, cause the computer system to identify the actual revenue amount from the advertiser corresponding to the winning bids during the first time period by identifying the actual revenue amount during the first time period and a second time period, wherein the second time period is a predetermined amount of time, and wherein the first time period and the second time period define a monitored time period.

19. The non-transitory computer-readable medium of claim 18, further storing instructions that, when executed by the at least one processor, cause the computer system to:
execute the digital advertising campaign during a third time period;
determine, for the third time period, that the digital advertising campaign is not an exploit campaign; and
based on determining that the digital advertising campaign is not an exploit campaign during the third time period, automatically un-throttle the digital advertising campaign by modifying the one or more of the campaign parameters to increase future winning bids associated with the digital advertising campaign.

20. The non-transitory computer-readable medium of claim 18, further storing instructions that, when executed by the at least one processor, cause the computer system to:
throttle a plurality of digital advertising campaigns;
determine that throttling the plurality of digital advertising campaigns exceeds a global throttling threshold; and
un-throttle the digital advertising campaign based on the determination that throttling the plurality of digital advertising campaigns exceeds the global throttling threshold.
